(19) United States
(12) Patent Application Publication
(10) Pub. No.: US 2026/0302698 A1
(43) Pub. Date: Oct. 1, 2026

(54) SYSTEM FOR CONNECTING AN ACCESSORY TO AN ITEM

(71) Applicant: BOMBARDIER RECREATIONAL PRODUCTS INC., Valcourt (CA)

(72) Inventors: Benjamin HOULE, Drummondville (CA); Jonathan ASSELIN, Magog (CA); Nicolas GAGNON, Sherbrooke (CA)

(21) Appl. No.: 19/697,982

(22) Filed: Jun. 4, 2026

Related U.S. Application Data
(63) Continuation-in-part of application No. 18/852,470, filed on Mar. 31, 2023.
(60) Provisional application No. 63/326,123, filed on Mar. 31, 2022.
(60) Provisional application No. 63/817,403, filed on Jun. 4, 2025.

(51) Int. Cl. H01R 13/73

(52) U.S. Cl. CPC H01R 13/73; H01R 2201/26

(57) ABSTRACT

A system for connecting an accessory to an item. The system includes an anchor fixture having a fixture body connectable to the item and defining an anchor aperture. A connector portion is connected to the fixture body and has an electrical element for electrically connecting to an electrical power source. The system includes an anchor having an anchor base connectable to the accessory and an anchor lock connected to the anchor base. The anchor lock is insertable through the anchor aperture and includes an electrical element for electrically connecting to the accessory. The anchor lock is movable between a locked position, where the anchor lock cannot pass through the anchor aperture and the two electrical elements contact, and an unlocked position, where the anchor lock can pass through the anchor aperture and the two electrical elements do have not contact.

### CROSS-REFERENCE

The present application is a continuation-in-part of U.S. patent application Ser. No. 18/852,470, filed Sep. 29, 2024, which is a national stage entry of International Application No. PCT/IB2023/053266, filed Mar. 31, 2023, which claims priority to United States Provisional Patent Application No. 63/326,123, entitled “SYSTEM FOR CONNECTING AN ACCESSORY TO AN ITEM,” filed on Mar. 31, 2022. The present application also claims priority to U.S. Provisional Patent Application No. 63/817,403, filed Jun. 4, 2025, entitled “System for Connecting an Accessory to an Item.” The entirety of each of the above listed applications is incorporated by reference herein.

### FIELD OF THE TECHNOLOGY

The present invention relates to systems and methods for attachment of accessories to a vehicle.

### BACKGROUND

Vehicles such as snowmobiles are often made to carry miscellaneous accessories for personal items, fuel, equipment, amongst others, in addition to passengers. For instance, the vehicles may be provided with racks and the like to carry cargo. The cargo items are often secured to parts of the vehicles by ropes, cords, tie-downs and the like. Anchoring systems including an anchor and an anchor fixture are also available to easily secure accessories to a vehicle. However, these solutions are often not easy to implement for smaller accessories that a driver of a vehicle may desire to keep on hand (e.g., a walkie-talkie). Furthermore, some powered accessories may be difficult to connect to a power source when stored. This may be particularly evident for smaller accessories.

Therefore, there is a desire for a system for connecting an accessory to an item that at least partly addresses these drawbacks.

### SUMMARY

It is an object of the present invention to ameliorate at least some of the inconveniences present in the prior art.

According to an aspect of the present technology, there is provided a system for connecting an accessory to an item, the system including an anchor fixture including a fixture body configured to be connected to the item, the fixture body defining an anchor aperture; and a first electrical element connected to the fixture body; and an anchor including an anchor base configured to be connected to the accessory, the anchor base including a second electrical element, the second electrical element being configured and arranged to contact the first electrical element to electrically connect the anchor fixture to the anchor when the anchor is connected to the anchor fixture; an anchor lock connected to the anchor base, the anchor lock being configured to be inserted through the anchor aperture of the anchor fixture, the anchor lock being movable relative to the anchor fixture between an unlocked position and a locked position, in the unlocked position, the anchor lock being free to pass through the anchor aperture, in the locked position, the anchor lock being prevented by the anchor fixture from passing through the anchor aperture; and the anchor being selectively secured to the anchor fixture by inserting the anchor lock through the anchor aperture and moving the anchor lock relative to the anchor fixture to place the anchor lock in the locked position.

In some embodiments, the first electrical element is a first pair of electrical contacts; and the second electrical element is a second pair of electrical contacts.

In some embodiments, the first electrical element is disposed along an aperture surface of the fixture body, the aperture surface defining the anchor aperture.

In some embodiments, the anchor includes a contact portion extending from the anchor base in a same direction as the anchor lock, the contact portion being shaped and arranged to be disposed in the anchor aperture when the anchor lock is selectively inserted in the anchor fixture; the second electrical element is disposed on the contact portion; and the first and second electrical elements are in contact when the contact portion is inserted into the anchor aperture.

In some embodiments, the anchor includes a magnetic contact disposed on the anchor body; the anchor fixture includes at least one magnetic switch operatively connected to the first electrical element; and the at least one magnetic switch is configured to permit operation of the first electrical element when activated by the magnetic contact.

In some embodiments, the at least one magnetic switch includes: a first magnetic switch disposed on a first side of the anchor aperture, and a second magnetic switch disposed on a second side of the anchor aperture, the second side being opposite the first side; the magnetic contact is aligned with the first magnetic switch when the anchor is connected to the anchor fixture in a first orientation, the first magnetic switch being configured to permit operation of the first electrical element with first polarity when activated by the magnetic contact; and the magnetic contact is aligned with the second magnetic switch when the anchor is connected to the anchor fixture in a second orientation, the second magnetic switch being configured to permit operation of the first electrical element with a second polarity when activated by the magnetic contact.

In some embodiments, the second orientation is 180 degrees rotated from the first orientation.

In some embodiments, the anchor fixture defines therein an anchor chamber, the anchor aperture opening into the anchor chamber; and the anchor fixture defines a tongue aperture in one side of the fixture body, the tongue aperture being configured to receive therethrough a toe-in portion of a tongue bracket.

In some embodiments, the system further includes a tongue bracket configured to be connected to the accessory.

In some embodiments, the anchor fixture is a first anchor fixture and the system further includes a second anchor fixture connected to the item; and the tongue fastener is positioned and arranged on the accessory and the second anchor fixture is position and arranged on the item such that a portion of the tongue fastener can be selectively received in the second anchor fixture when the anchor is connected to the first anchor fixture.

In some embodiments, the anchor lock is rotated relative to the anchor base when moved between the unlocked position and the locked position.

In some embodiments, the anchor further includes a lever operatively connected to the anchor lock, the lever being rotatable to cause the anchor lock to rotate between the unlocked position and the locked position.

In some embodiments, the anchor further includes a stem extending from the anchor base, the anchor lock extending from the stem.

In some embodiments, the anchor lock includes two cams extending from opposite sides of the stem.

In some embodiments, the anchor fixture defines an anchor chamber, the anchor aperture opening into the anchor chamber; the anchor lock is configured to be inserted through the anchor aperture into the anchor chamber; and in the locked position, the anchor lock is disposed in the anchor chamber.

In some embodiments, the anchor fixture includes at least one switch operatively connected to the first electrical element; and the at least one switch is configured to change polarity of the first electrical element in response to an orientation of the anchor connected to the anchor fixture.

In some embodiments, the anchor aperture is a hexagonal aperture; the hexagonal aperture is defined by two end side portions and four longitudinal side portions; each of the two end side portions are shorter than each of the four longitudinal side portions; and each electrical contact of the first pair of electrical contacts is disposed on one of the two end side portions.

According to an aspect of the present technology, there is provided a system for connecting an accessory to an item, the system including an anchor fixture including a fixture body configured to be connected to the item, the fixture body defining an anchor aperture; and a first electrical element connected to the fixture body; and an anchor including an anchor base configured to be connected to the accessory, the anchor base including a second electrical element, the second electrical element being configured and arranged to contact the first electrical element to electrically connect the anchor fixture to the anchor when the anchor is connected to the anchor fixture; an anchor lock connected to the anchor base, the anchor lock being configured to be inserted through the anchor aperture of the anchor fixture, the anchor being movable relative to the anchor fixture between an unlocked position and a locked position, in the unlocked position, at least a portion of the anchor being free to pass through the anchor aperture, in the locked position, at least a portion of the anchor being prevented by the anchor fixture from passing through the anchor aperture; and the anchor being selectively secured to the anchor fixture by inserting at least a portion of the anchor into the anchor fixture through the anchor aperture.

In some embodiments, the first electrical element is a first pair of electrical contacts; and the second electrical element is a second pair of electrical contacts.

In some embodiments, the first electrical element is disposed along an aperture surface of the fixture body, the aperture surface defining the anchor aperture.

In some embodiments, the anchor includes a contact portion extending from the anchor base in a same direction as the anchor lock, the contact portion being shaped and arranged to be disposed in the anchor aperture when the anchor lock is selectively inserted in the anchor fixture; the second electrical element is disposed on the contact portion; and the first and second electrical elements are in contact when the contact portion is inserted into the anchor aperture.

According to another aspect of the present technology, there is provided a system for connecting an accessory to an item, the system including an anchor fixture including a fixture body configured to be connected to one of the accessory and the item, the fixture body defining an anchor aperture; and a first electrical element connected to the fixture body; and an anchor including an anchor base configured to be connected to an other one of the accessory and the item; an anchor lock connected to the anchor base, the anchor lock being configured to be inserted through the anchor aperture of the anchor fixture, the anchor lock being movable relative to the anchor fixture between an unlocked position and a locked position, in the unlocked position, the anchor lock being free to pass through the anchor aperture, in the locked position, the anchor lock being prevented by the anchor fixture from passing through the anchor aperture, the anchor being selectively secured to the anchor fixture by inserting the anchor lock through the anchor aperture and moving the anchor lock relative to the anchor fixture to place the anchor lock in the locked position; and a second electrical element configured to contact the first electrical element to electrically connect the anchor fixture to the anchor, a given one of the first electrical element and the second electrical element that is configured to be connected to the accessory being configured to be electrically connected to the accessory.

In some embodiments, the second electrical element is disposed on one of the anchor base and the anchor lock.

In some embodiments, the anchor further includes an anchor power connector configured to electrically connect the anchor to one of the accessory and a power source, the anchor power connector being electrically connected to the second electrical element to conduct electricity between the second electrical element and the one of the accessory and the power source.

In some embodiments, the anchor fixture includes a fixture power connector configured to electrically connect the anchor fixture to an other one of the accessory and the power source, the fixture power connector being electrically connected to the first electrical element to conduct electricity between the first electrical element and the other one of the accessory and the power source.

In some embodiments, the anchor fixture defines an anchor chamber, the anchor aperture opening into the anchor chamber; the anchor lock is configured to be inserted through the anchor aperture into the anchor chamber; and in the locked position, the anchor lock is disposed in the anchor chamber.

In some embodiments, one of the first electrical element and the second electrical element comprises at least one spring loaded pin configured to retract in response to the anchor lock being in the anchor chamber and placed in the locked position.

In some embodiments, the one of the first electrical element and the second electrical element is the second electrical element.

In some embodiments, the first electrical element is disposed within the anchor chamber.

In some embodiments, the anchor fixture further includes a backing member defining the anchor chamber together with the fixture body, the backing member comprising the first electrical element.

In some embodiments, the first electrical element is disposed on a top surface of the anchor fixture.

In some embodiments, the anchor further includes a lever operatively connected to the anchor lock, the lever being rotatable to cause the anchor lock to rotate between the unlocked position and the locked position.

In some embodiments, the anchor base has a lower surface, the anchor lock being spaced from the lower surface.

In some embodiments, the anchor further includes a stem extending from the anchor base, the anchor lock extending from the stem.

In some embodiments, the anchor lock includes two cams extending from opposite sides of the stem.

In some embodiments, an entirety of the anchor is rotated to move the anchor lock between the unlocked position and the locked position.

In some embodiments, the fixture body is configured to be connected to the item; and the anchor base is configured to be connected to the accessory.

According to another aspect of the present technology, there is provided an anchor for connecting an accessory to an item, including an anchor base configured to be connected to the accessory; an anchor lock connected to the anchor base, the anchor lock being configured to be inserted into an anchor chamber of an anchor fixture connected to the item, the anchor lock being movable relative to the anchor fixture between an unlocked position and a locked position, in the unlocked position, the anchor lock being free to be removed from the anchor chamber through an anchor aperture of the anchor fixture, in the locked position, the anchor lock being disposed in the anchor chamber and being prevented by the anchor fixture from being removed from the anchor chamber through the anchor aperture, the anchor being configured to be selectively secured to the anchor fixture by inserting the anchor lock into the anchor chamber and moving the anchor lock relative to the anchor fixture to place the anchor lock in the locked position; and an anchor electrical element configured to contact a corresponding fixture electrical element of the anchor fixture to electrically connect the anchor to the anchor fixture, the anchor electrical element being configured to be electrically connected to the accessory.

In some embodiments, the anchor further includes an anchor power connector configured to electrically connect the anchor to the accessory, the anchor power connector being electrically connected to the anchor electrical element to conduct electricity to the accessory.

In some embodiments, the anchor electrical element comprises at least one spring loaded pin configured to retract in response to the anchor lock being in the anchor chamber and placed in the locked position.

In some embodiments, the anchor electrical element is disposed on one of the anchor base and the anchor lock.

In some embodiments, the anchor base has a lower surface, the anchor lock being spaced from the lower surface.

In some embodiments, the anchor further includes a stem extending from the anchor base, the anchor lock extending from the stem.

In some embodiments, the anchor lock includes two cams extending from opposite sides of the stem.

In some embodiments, an entirety of the anchor is rotated to move the anchor lock between the unlocked position and the locked position.

In some embodiments, the anchor further includes a lever operatively connected to the anchor lock, the lever being rotatable to cause the anchor lock to rotate between the unlocked position and the locked position.

According to another aspect of the present technology, there is provided a system for connecting an accessory to an item. The system comprises: an anchor fixture configured to be connected to one of the accessory and the item, the anchor fixture defining an anchor chamber and an anchor aperture opening into the anchor chamber; and an anchor configured to be connected to an other one of the accessory and the item, the anchor comprising an anchor lock, the anchor lock being configured to be inserted through the anchor aperture and into the anchor chamber of the anchor fixture, the anchor lock being rotatable relative to the anchor fixture between an unlocked position and a locked position, in the unlocked position, the anchor lock being free to pass through the anchor aperture, in the locked position, the anchor lock being disposed in the anchor chamber and being prevented by the anchor fixture from passing through the anchor aperture, an entirety of the anchor being rotated to move the anchor lock between the unlocked position and the locked position, the anchor being selectively secured to the anchor fixture by inserting the anchor lock into the anchor chamber and moving the anchor lock relative to the anchor fixture to place the anchor lock in the locked position.

In some embodiments, the anchor comprises an anchor base having a lower surface, the anchor lock being spaced from the lower surface.

In some embodiments, the anchor further comprises a stem extending from the anchor base, the anchor lock extending from the stem.

In some embodiments, the anchor lock comprises two cams extending from opposite sides of the stem.

In some embodiments, the anchor comprises an accessory mount for connection to the accessory.

In some embodiments, the one of the accessory and the item is the item.

In some embodiments, the anchor fixture comprises an edge portion configured to be sewn to the item.

In some embodiments, the anchor fixture comprises a first electrical element; the anchor comprises a second electrical element; and the first and second electrical elements are configured to be in contact with each other to establish electrical communication therebetween.

In some embodiments, the anchor further comprises a latching feature for selectively engaging the anchor fixture to prevent rotation of the anchor lock from the locked position to the unlocked position.

In some embodiments, the latching feature comprises a latching protrusion that is selectively insertable within an aperture defined by the anchor fixture, the latching protrusion preventing rotation of the anchor lock from the locked position to the unlocked position in response to the latching protrusion being inserted into the aperture.

In some embodiments, the aperture is the anchor aperture.

In some embodiments, the anchor further comprises a handle for handling by a user, the handle being operatively connected to the latching feature such that the latching feature is actuated by operation of the handle.

In some embodiments, the anchor chamber is defined on a concave side of the anchor fixture.

In some embodiments, the anchor fixture comprises at least one interlocking member disposed in the anchor chamber, the at least one interlocking member being configured to engage the anchor lock in the locked position to retain the anchor lock.

According to another aspect of the present technology, there is provided a garment accessory system. The garment accessory system comprises: a garment comprising a textile body; an accessory comprising an accessory body; an anchor fixture connected to one of the textile body and the accessory body, the anchor fixture at least partly defining an anchor chamber, the anchor fixture defining an anchor aperture opening into the anchor chamber; an anchor connected to an other one of the textile body and the accessory body, the anchor comprising an anchor lock configured to be inserted through the anchor aperture and into the anchor chamber, the anchor lock being rotatable relative to the anchor fixture between an unlocked position and a locked position, in the unlocked position, the anchor lock being free to pass through the anchor aperture, in the locked position, the anchor lock being disposed in the anchor chamber and being prevented by the anchor fixture from passing through the anchor aperture, the anchor being selectively secured to the anchor fixture by inserting the anchor lock into the anchor chamber and moving the anchor lock relative to the anchor fixture to place the anchor lock in the locked position.

In some embodiments, the one of the textile body and the accessory body is the textile body.

In some embodiments, an entirety of the anchor is rotated to move the anchor lock between the unlocked position and the locked position.

In some embodiments, the anchor fixture is sewn to the textile body.

In some embodiments, a stitching connecting the anchor fixture to the textile body surrounds the anchor chamber.

In some embodiments, the anchor fixture comprises a first electrical element; the anchor comprises a second electrical element; and the first and second electrical elements are configured to be in contact with each other to establish electrical communication therebetween.

In some embodiments, the garment further comprises a power connector configured to connect the garment to a power source, the power connector being in electrical communication with the first electrical element of the anchor fixture.

In some embodiments, the power connector is configured to be connected to a power source of a vehicle.

In some embodiments, the anchor fixture comprises a wall portion defining the anchor aperture; the first electrical element comprises a first contact portion; the second electrical element comprises a second contact portion; and in the locked position of the anchor lock, the first and second contact portions are disposed within the anchor chamber between the textile body and the wall portion of the anchor fixture.

In some embodiments, the anchor further comprises a latching feature for selectively engaging the anchor fixture to prevent rotation of the anchor lock from the locked position to the unlocked position.

In some embodiments, the latching feature comprises a latching protrusion that is selectively insertable within an aperture defined by the anchor fixture, the latching protrusion preventing rotation of the anchor lock from the locked position to the unlocked position in response to the latching protrusion being inserted into the aperture.

In some embodiments, the aperture is the anchor aperture.

In some embodiments, the anchor further comprises a handle for handling by a user, the handle being operatively connected to the latching feature such that the latching feature is actuated by operation of the handle.

In some embodiments, the garment is one of a jacket, a pair of pants and a personal floatation device. In some embodiments, the accessory is one of a walkie-talkie and an electronic navigation device.

In some embodiments, the anchor fixture comprises at least one interlocking member disposed in the anchor chamber. the at least one interlocking member being configured to engage the anchor lock in the locked position to retain the anchor lock.

In some embodiments, an entirety of the accessory is rotated to move the anchor lock between the unlocked position and the locked position.

According to another aspect of the present technology, there is provided a system for connecting an accessory to an item. The system comprises: an anchor fixture comprising: a fixture body configured to be connected to one of the accessory and the item, the fixture body defining an anchor aperture; and a first electrical element connected to the fixture body; and an anchor comprising: an anchor base configured to be connected to an other one of the accessory and the item; an anchor lock connected to the anchor base, the anchor lock being configured to be inserted through the anchor aperture of the anchor fixture, the anchor lock being movable relative to the anchor fixture between an unlocked position and a locked position, in the unlocked position, the anchor lock being free to pass through the anchor aperture, in the locked position, the anchor lock being prevented by the anchor fixture from passing through the anchor aperture, the anchor being selectively secured to the anchor fixture by inserting the anchor lock through the anchor aperture and moving the anchor lock relative to the anchor fixture to place the anchor lock in the locked position; and a second electrical element configured to contact the first electrical element to electrically connect the anchor fixture to the anchor, a given one of the first electrical element and the second electrical element that is configured to be connected to the accessory being configured to be electrically connected to the accessory.

In some embodiments, the second electrical element is disposed on one of the anchor base and the anchor lock.

In some embodiments, the anchor further comprises an anchor power connector configured to electrically connect the anchor to one of the accessory and a power source, the anchor power connector being electrically connected to the second electrical element to conduct electricity between the second electrical element and the one of the accessory and the power source.

In some embodiments, the anchor fixture comprises a fixture power connector configured to electrically connect the anchor fixture to an other one of the accessory and the power source, the fixture power connector being electrically connected to the first electrical element to conduct electricity between the first electrical element and the other one of the accessory and the power source.

In some embodiments, the anchor fixture defines an anchor chamber, the anchor aperture opening into the anchor chamber; the anchor lock is configured to be inserted through the anchor aperture into the anchor chamber; and in the locked position, the anchor lock is disposed in the anchor chamber.

In some embodiments, one of the first electrical element and the second electrical element comprises at least one spring loaded pin configured to retract in response to the anchor lock being in the anchor chamber and placed in the locked position.

In some embodiments, the one of the first electrical element and the second electrical element is the second electrical element.

In some embodiments, the first electrical element is disposed within the anchor chamber.

In some embodiments, the anchor fixture further comprises a backing member defining the anchor chamber together with the fixture body, the backing member comprising the first electrical element.

In some embodiments, the first electrical element is disposed on a top surface of the anchor fixture.

In some embodiments, the anchor further comprises a lever operatively connected to the anchor lock, the lever being rotatable to cause the anchor lock to rotate between the unlocked position and the locked position.

In some embodiments, the anchor base has a lower surface, the anchor lock being spaced from the lower surface.

In some embodiments, the anchor further comprises a stem extending from the anchor base, the anchor lock extending from the stem.

In some embodiments, the anchor lock comprises two cams extending from opposite sides of the stem.

In some embodiments, an entirety of the anchor is rotated to move the anchor lock between the unlocked position and the locked position.

In some embodiments, the fixture body is configured to be connected to the item; and the anchor base is configured to be connected to the accessory.

According to another aspect of the present technology there is provided an anchor for connecting an accessory to an item. The anchor comprises: an anchor base configured to be connected to the accessory; an anchor lock connected to the anchor base, the anchor lock being configured to be inserted through into an anchor chamber of an anchor fixture connected to the item, the anchor lock being movable relative to the anchor fixture between an unlocked position and a locked position, in the unlocked position, the anchor lock being free to be removed from the anchor chamber through an anchor aperture of the anchor fixture, in the locked position, the anchor lock being disposed in the anchor chamber and being prevented by the anchor fixture from being removed from the anchor chamber through the anchor aperture, the anchor being configured to be selectively secured to the anchor fixture by inserting the anchor lock into the anchor chamber and moving the anchor lock relative to the anchor fixture to place the anchor lock in the locked position; and an anchor electrical element configured to contact a corresponding fixture electrical element of the anchor fixture to electrically connect the anchor to the anchor fixture, the anchor electrical element being configured to be electrically connected to the accessory.

In some embodiments, the anchor further comprises an anchor power connector configured to electrically connect the anchor to the accessory, the anchor power connector being electrically connected to the anchor electrical element to conduct electricity to the accessory.

In some embodiments, the anchor electrical element comprises at least one spring loaded pin configured to retract in response to the anchor lock being in the anchor chamber and placed in the locked position.

In some embodiments, the anchor electrical element is disposed on one of the anchor base and the anchor lock.

In some embodiments, the anchor base has a lower surface, the anchor lock being spaced from the lower surface.

In some embodiments, the anchor further comprises a stem extending from the anchor base, the anchor lock extending from the stem.

In some embodiments, the anchor lock comprises two cams extending from opposite sides of the stem.

In some embodiments, an entirety of the anchor is rotated to move the anchor lock between the unlocked position and the locked position.

In some embodiments, the anchor further comprises a lever operatively connected to the anchor lock, the lever being rotatable to cause the anchor lock to rotate between the unlocked position and the locked position.

In some aspects, there is provided a system for connecting an accessory to an item, the system including: an anchor fixture including: a fixture body configured to be connected to the item, the fixture body defining an anchor aperture; and a connector portion connected to the fixture body, the connector portion having a first electrical element configured to electrically connect to an electrical power source; and an anchor including: an anchor base configured to be connected to the accessory; and an anchor lock connected to the anchor base, the anchor lock being configured to be inserted through the anchor aperture of the anchor fixture, the anchor lock including a second electrical element configured to electrically connect to the accessory, the anchor lock being movable relative to the anchor fixture between an unlocked position and a locked position, in the locked position, the anchor lock is prevented from passing through the anchor aperture and the second electrical element contacts the first electrical element to electrically connect the anchor fixture to the anchor, in the unlocked position, the anchor lock is free to pass through the anchor aperture and the second electrical element does not contact the first electrical element; and the anchor being selectively secured to the anchor fixture by inserting the anchor lock through the anchor aperture and moving the anchor lock relative to the anchor fixture to place the anchor lock in the locked position.

In some aspects, there is provided a system, wherein the connector portion is removably connected to the fixture body.

In some aspects, there is provided a system, wherein: the anchor base includes a first face; the fixture body includes: a first surface, at least a portion of the first surface being in contact with the first face of the anchor base when the anchor lock is selectively inserted through the anchor aperture; and a second surface; and the connector portion being connected to the second surface of the fixture body.

In some aspects, there is provided a system, wherein the second surface of the fixture body is opposite to the first surface of the fixture body.

In some aspects, there is provided a system, wherein the first electrical element is positioned on the connector portion such that the second surface of the fixture body is located between the first surface and the first electrical element.

In some aspects, there is provided a system, wherein: the anchor lock defines a plane, the plane contains and extends along a central axis of the anchor lock; the first electrical element being disposed on a first side of the plane; and in the locked position, the second electrical element contacts the first electrical element on the first side of the plane.

In some aspects, there is provided a system, wherein: the first electrical element is a first pair of electrical contacts; and the second electrical element is a second pair of electrical contacts.

In some aspects, there is provided a system, wherein the second electrical element is connected to a first end of an electrical lead, the electrical lead extending from the anchor lock towards the anchor base, at least a portion of the electrical lead being movable with the anchor lock.

In some aspects, there is provided a system, wherein: the anchor base defines an electrical lead opening; and a second end of the electrical lead extending through the electrical lead opening.

In some aspects, there is provided a system, wherein the anchor further includes an anchor power connector electrically connected to the second end of the electrical lead, the anchor power connector being connectable to the accessory for electrically connecting the anchor to the accessory.

In some aspects, there is provided a system, wherein: the anchor further includes a stem extending from the anchor base, the anchor lock extending away from the stem; the anchor lock includes at least one cam extending from the stem; and the first electrical element being disposed on the at least one cam.

In some aspects, there is provided a system, wherein the connector portion further includes a fixture power connector electrically connected to the first electrical element, the fixture power connector being connectable to the item for electrically connecting the anchor fixture to the item.

In some aspects, there is provided a system, wherein the anchor lock is rotatable relative to the anchor base.

In some aspects, there is provided a system, wherein the anchor further includes a lever operatively connected to the anchor lock, the lever being rotatable to cause the anchor lock to rotate between the locked position and the unlocked position.

In some aspects, there is provided a system, wherein the fixture body defines a recessed portion extending inwardly from an outer edge of the fixture body.

In some aspects, there is provided a system, wherein the anchor further includes a plate connected to the anchor base.

In some aspects, there is provided a system, further including the accessory, wherein: the accessory is a light connected to the anchor base, the light being activatable when the anchor lock is in the locked position.

In some aspects, there is provided a system, wherein the item is a part of a vehicle.

For purposes of the present application, terms related to spatial orientation when referring to a vehicle and components in relation to the vehicle, such as “forwardly”, “rearwardly”, “left”, “right”, “above” and “below”, are as they would be understood by a driver of the vehicle, with the vehicle, in a straight ahead orientation (i.e. not steered left or right), and in an upright position. When referring to a component alone, terms related to spatial orientation should be taken with respect to the component itself. The explanations provided above regarding the above terms take precedence over explanations of these terms that may be found in any one of the documents referenced herein.

For purposes of the present application, the accessory could be implemented as a variety of objects. The accessory could be one or more of, but is not limited to, storage containers, bags, pouches, nets, speakers, lights or illumination devices, communication devices (for example, walkie-talkies), toolkits, fishing pouch/tools, hunting tools, winch remotes, quick detaches for vehicle body panels, helmets, helmet accessories, cameras, phones, food containers, and water bottles.

Embodiments of the present invention each have at least one of the above-mentioned object and/or aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a right side elevation view of a snowmobile;

FIG. 2 is a perspective view, taken from a top, rear, right side, of a system for connecting an accessory to the snowmobile of FIG. 1;

FIG. 3 is a perspective view, taken from a top, rear, left side, of an anchor fixture and an anchor of the system of FIG. 2 shown in a disassembled configuration;

FIG. 4 is a perspective view, taken from a top, front, left side, of the anchor fixture and the anchor of FIG. 3;

FIG. 5 is a perspective view, taken from a top, rear, left side, of the anchor fixture and the anchor of FIG. 3, shown with the anchor secured to the anchor fixture;

FIG. 6 is a perspective view, taken from a top, front, left side, of the anchor fixture and the anchor of FIG. 5;

FIG. 7 is a perspective view, taken from a top, front, right side, of the anchor fixture and the anchor of FIG. 5;

FIG. 8 is a bottom plan view of the anchor fixture and the anchor of FIG. 5;

FIG. 9 is a bottom plan view of the anchor fixture and the anchor of FIG. 3, shown with an anchor lock of the anchor in an unlocked position;

FIG. 10 is a front elevation view of a garment having a plurality of systems for connecting accessories to a garment body of the garment;

FIG. 11 is a top perspective view of one of the systems of FIG. 10;

FIG. 12 is a perspective view, taken from a top, front, right side, of the system of FIG. 11, shown with an anchor and an anchor fixture thereof in a disassembled configuration;

FIG. 13 is a perspective view, taken from a bottom, front, right side, of the system of FIG. 12;

FIG. 14 is a perspective view, taken from a top, front, left side, of the system of FIG. 11, shown with the anchor and the anchor fixture thereof assembled and with an anchor lock of the anchor being in an unlocked position;

FIG. 15 is a front elevation view of the system of FIG. 11, shown with the anchor lock being in a locked position and a latching feature of the anchor being in an unlatched position;

FIG. 16 is a perspective view, taken from a top, front, left side, of the system of FIG. 11, shown with the anchor lock being in a locked position and the latching feature being in a latched position;

FIG. 17 is a bottom plan view of the system of FIG. 16;

FIG. 18 is a top plan view of the anchor fixture of the system of FIG. 11;

FIG. 19A is a top plan view of an alternative embodiment of the anchor fixture of the system of FIG. 11;

FIG. 19B is a top plan view of another alternative embodiment of the anchor fixture of the system of FIG. 11;

FIG. 20 is a bottom perspective view of another embodiment of the anchor of the system of FIG. 11, shown connected to an accessory and with the latching feature thereof in the latched position;

FIG. 21 is a bottom perspective view of the anchor and the accessory of FIG. 20, shown with the latching feature thereof in the unlatched position;

FIG. 22 is a perspective view of a cross-section of the anchor and accessory of FIG. 20 and a corresponding anchor fixture connected to a textile body of the garment;

FIG. 23 is a perspective view, taken from a top, front, left side, of another one of the systems of FIG. 10 including an anchor and an anchor fixture connected to each other;

FIG. 24 is a top plan view of the system of FIG. 23;

FIG. 25 is a perspective view of the anchor fixture and the anchor of FIG. 23, showing a top side of the anchor fixture and a bottom side of the anchor;

FIG. 26 is a perspective view of a cross-section taken along line 26-26 in FIG. 24;

FIG. 27 is a perspective view of a cross-section taken along line 27-27 in FIG. 24;

FIG. 28 is a plan view of the anchor fixture and the anchor of FIG. 23 with a backing member of the anchor fixture separated therefrom, a bottom side of a fixture body and the anchor and a top side of a backing member being shown;

FIG. 29 is a front elevation view of a garment having a plurality of systems for connecting accessories to a garment body of the garment, whereby the garment is connected to an external power source;

FIG. 30 is a perspective view, taken from a top, rear, right side, of a system for connecting an accessory to an item according to the present technology, shown with an anchor and an anchor fixture thereof in a disassembled configuration;

FIG. 31 is a partially exploded perspective view, taken from a top, rear, right side, of the system of FIG. 30;

FIG. 32 is partially exploded perspective view, taken from a top, rear, right side, of the anchor fixture of FIG. 30;

FIG. 33 is a top plan view of the anchor fixture of FIG. 30;

FIG. 34 is an exploded, rear, right side perspective view of the anchor fixture of FIG. 30;

FIG. 35 is a bottom plan view of the system of FIG. 30, shown with the anchor and the anchor fixture thereof in an assembled configuration;

FIG. 36 is a cross-sectional view of the assembled system of FIG. 30, taken along line 36-36 of FIG. 35;

FIG. 37 is a bottom plan view of the system of FIG. 30 and a tongue fastener;

FIG. 38 is a perspective view of an accessory with the system of FIG. 30 and the tongue fastener of FIG. 37;

FIG. 39 depicts a perspective view taken from a top, front, right side of a system for connecting an accessory to the snowmobile of FIG. 1;

FIG. 40 depicts a perspective view taken from a top, front, right side of the system of FIG. 39, shown with an anchor and an anchor fixture thereof in a disassembled configuration;

FIG. 41 depicts a perspective view taken from a bottom, rear, right side of the anchor fixture of FIG. 40;

FIG. 42 depicts an exploded perspective view taken from a bottom, rear, right side of the anchor fixture of FIG. 40;

FIG. 43 depicts an exploded perspective view taken from a bottom, rear, right side of the anchor fixture of FIG. 40, shown with a connector portion of the anchor fixture rendered partially transparent;

FIG. 44 depicts a top plan view of an alternative embodiment of an anchor fixture;

FIG. 45 depicts an exploded perspective view taken from a top, rear, left side of the anchor of FIG. 40;

FIG. 46 depicts a perspective view taken from a top, rear, left side of the anchor of FIG. 40, shown with an anchor base and an anchor lock rendered partially transparent;

FIG. 47 depicts a bottom plan view of the system of FIG. 39 with the anchor lock in an unlocked position, shown with the anchor lock and the connector portion rendered partially transparent;

FIG. 48 depicts a bottom plan view of the system of FIG. 39 with the anchor lock in a locked position, shown with the anchor lock and the connector portion rendered partially transparent;

FIG. 49 depicts an alternative embodiment of a system for connecting an accessory to the snowmobile of FIG. 1; and

FIG. 50 depicts an alternative embodiment of a system for connecting an accessory to the snowmobile of FIG. 1.

### DETAILED DESCRIPTION

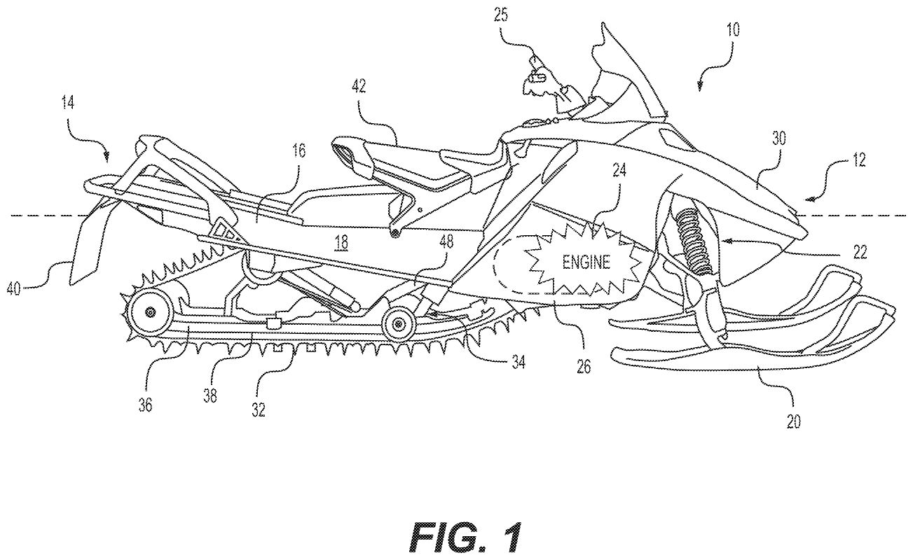

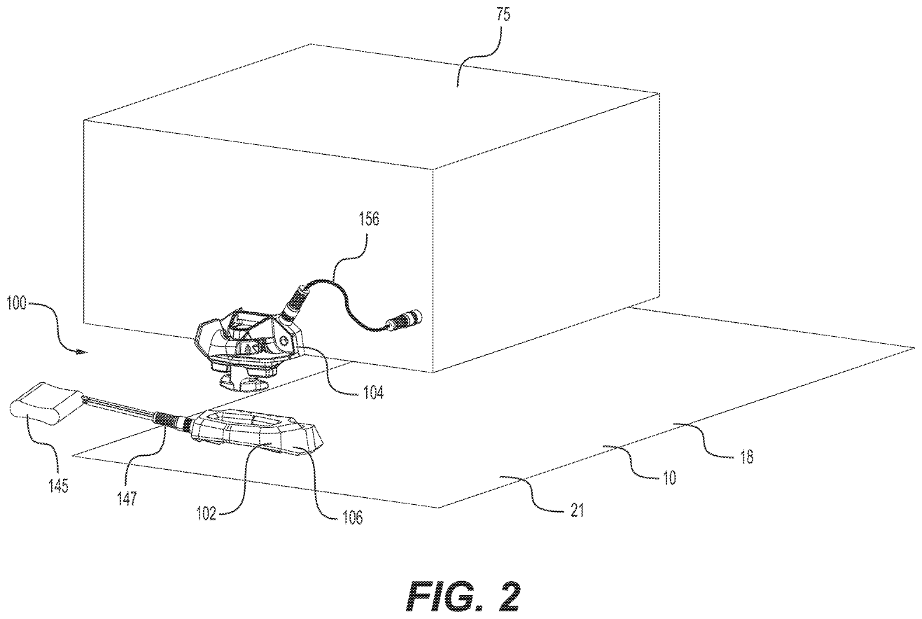

As will be described herein and as shown in FIG. 2, a system 100 is broadly provided for connecting an accessory 75 to an item such as a part of a vehicle 10 (FIG. 1). The vehicle 10 may be any suitable vehicle. In this embodiment, the vehicle 10 is a snowmobile. The snowmobile 10 will be broadly described with reference to FIG. 1. It should be understood that the snowmobile 10 could have a construction different than the one described.

The snowmobile 10 has a front end 12 and a rear end 14, which are defined with respect to a forward travel direction of the snowmobile 10. The snowmobile 10 has a frame 16 which includes a tunnel 18. Skis 20 and a steering assembly 22 are provided at the front end 12 of the snowmobile 10. The steering assembly 22 includes a handlebar 25 that is operable by a driver of the snowmobile 10 to steer the snowmobile 10. A motor 24 and a belt transmission system 26 (shown schematically) disposed near the front end 12 are enclosed by fairings 30 which protect the engine 24 and the belt transmission system 26. In this embodiment, the motor 24 is an internal combustion engine.

In the rear section of the snowmobile 10, an endless drive track 32 is disposed under the tunnel 18. The endless drive track 32 is operatively connected to the engine 24 through the belt transmission system 26. The endless drive track 32 is driven to run about a rear suspension assembly 34 for propulsion of the snowmobile 10. The rear suspension assembly 34 includes a slide frame assembly 36 which includes a pair of spaced apart slide rails 38 that engage the inner side of the ground-engaging portion of the endless drive track 32. A snowflap 40 is disposed at the rear end 14 of the snowmobile 10.

A driver seat 42 is installed in the rear section of the snowmobile 10. A rear portion of the driver seat 42 may include a storage compartment, or may be used to accept a passenger seat.

With reference to FIG. 2, the system 100 includes an anchor fixture 102 that is fixable to the snowmobile 10, and an anchor 104 that is mateable with the anchor fixture 102. The anchor fixture 102 can be connected to any suitable part of the snowmobile 10. For instance, in this embodiment, the anchor fixture 102 is connected to an upper surface 21 of the tunnel 18. The anchor fixture 102 may be connected to another part of the snowmobile 10 in other embodiments (e.g., an accessory-receiving rack or other structure).

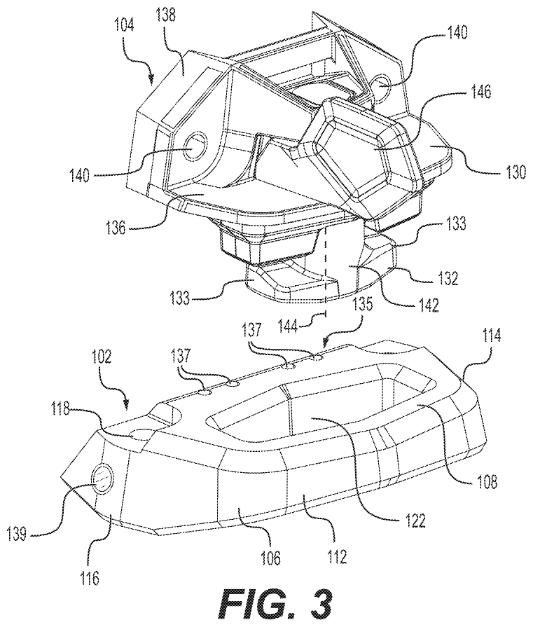

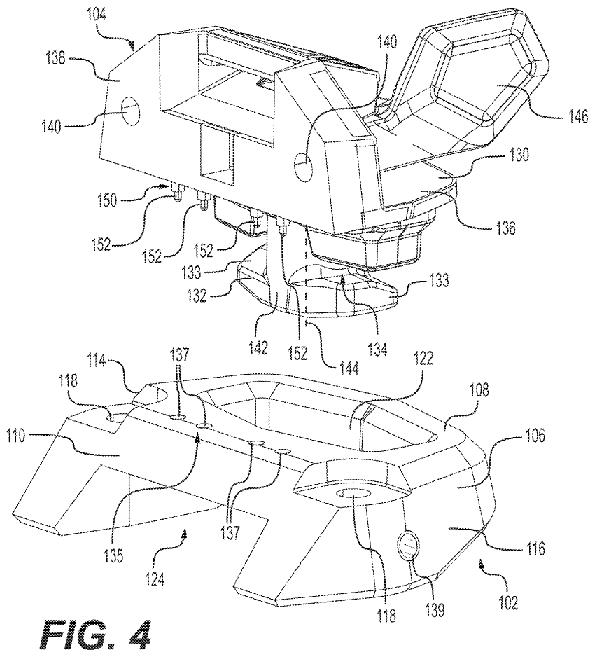

With reference to FIGS. 3 and 4, in this embodiment, the anchor fixture 102 has a fixture body 106 including a top wall portion 108, a front wall portion 110, a rear wall portion 112, a left side wall portion 114 and a right side wall portion 116. Each of the wall portions 108, 110, 112, 114, 116 has an interior surface and an exterior surface. As best shown in FIG. 4, the left and right side wall portions 114, 116 define openings 118 for receiving respective fasteners (e.g., bolts) to connect the anchor fixture 102 to the upper surface 21 of the tunnel 18. The interior surfaces of the wall portions 108, 110, 112, 114, 116 define an anchor chamber 120 that, as will be described in more detail below, is configured to receive therein a part of the anchor 104. The top wall portion 108 also defines an anchor aperture 122 that opens into the anchor chamber 120. As will be described below, part of the anchor 104 is inserted into the anchor chamber 120 through the anchor aperture 122 in order to secure the anchor 104 to the anchor fixture 102. In this embodiment, the front portion 110 also defines a fastener aperture 124 that opens into the anchor chamber 120. The fastener aperture 124 can be optionally used for inserting a tongue fastener (not shown) therein, thereby providing another way in which to secure an accessory to the anchor fixture 102. It is contemplated that the fastener aperture 124 could be omitted in other embodiments. An anchor fixture having this general structure is described in greater detail in U.S. Pat. No. 9,751,592, issued Sep. 5, 2017, the entirety of which is incorporated by reference herein. It is contemplated that the anchor fixture 102 may be configured differently in other embodiments. For instance, in some embodiments, the anchor fixture 102 could be a rack attached to the snowmobile 10 and defining the anchor aperture 122. In such embodiments, the anchor fixture 102 may not define an anchor chamber but rather simply a space below the top wall portion 108.

In this embodiment, the anchor fixture 102 also has a fixture electrical element 135 for establishing electrical communication between the anchor fixture 102 and the anchor 104. As can be seen, the fixture electrical element 135 is connected to the fixture body 106, namely being disposed on an outer surface of the top wall portion 108. Other positions of the fixture electrical element 135 are contemplated in other embodiments. In this embodiment, the fixture electrical element 135 includes a plurality of electrical contacts 137 made of an electrically conductive material (e.g., copper). The electrical contacts 137 are aligned with one another in a front-to-rear direction and laterally spaced from one another. Other arrangements of the electrical contacts 137 are also contemplated. As shown in FIG. 3, the anchor fixture 102 also has a fixture power connector 139 configured to electrically connect the anchor fixture 102 to a power source 145 (FIG. 2). In particular, the fixture power connector 139 is electrically connected to the electrical contacts 137 in order to conduct electricity between the electrical contacts 137 and the power source 145. In this embodiment, the fixture power connector 139 is a power receptacle configured for receiving a power plug that is electrically connected to the power source 145 via wiring 147. It is contemplated that, in other embodiments, the fixture power connector 139 could be hardwired instead of selectively receiving the power plug (i.e., the wiring 147 is fixedly attached to the anchor fixture 102 to electrically connect the anchor fixture 102 to the power source 145. In this embodiment, the power source 145 is a portable battery pack. It is contemplated that the power source 145 could be any other suitable power source in other embodiments, such as a battery of the snowmobile 10.

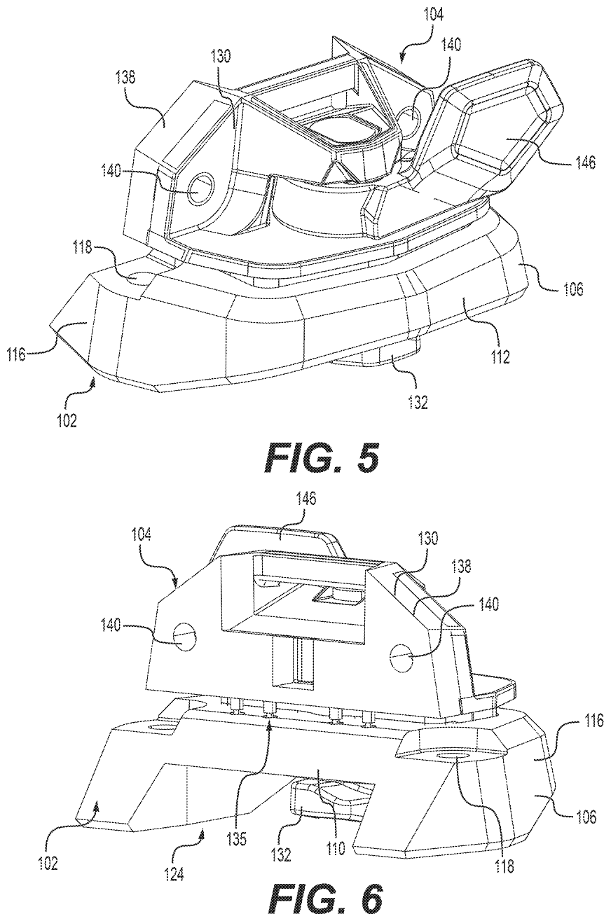

Turning to the anchor 104, with reference to FIGS. 3 and 4, in this embodiment, the anchor 104 has an anchor base 130 and an anchor lock 132 extending below the anchor base 130, spaced therefrom by a gap 134. The anchor base 130 has a horizontal portion 136 and an upright portion 138 generally perpendicular to the horizontal portion 136. The upright portion 138 is configured to be connected to a body of the accessory 75 (FIG. 2). Notably, in this embodiment, the upright portion 138 defines two fastener openings 140 for receiving respective fasteners (not shown) that engage the body of the accessory 75 such as to connect the anchor base 130 to the accessory 75. The anchor lock 132 is connected to the anchor base 130 via a stem 142 defining an axis 144. The anchor lock 132 includes two cams 133 extending from opposite sides of the stem 142 in opposite directions from each other. A lever 146 is connected to the stem 142, above the horizontal portion 136. The lever 146 allows a user to rotate the stem 142 about the axis 144, thereby rotating the anchor lock 132. In particular, the anchor lock 132 is rotatable about the axis 144 between locked and unlocked positions. In the unlocked position, illustrated in FIGS. 3 and 4, the anchor lock 132 extends generally parallel to the anchor base 130 such that the cams 133 are offset from one another in a direction of elongation of the anchor base 130. In the locked position, illustrated in FIGS. 5 to 8, the anchor lock 132 is rotated by 90° about the axis 144 relative to the unlocked position. A more complete description of the general structure of the anchor 104 can be found in U.S. Pat. No. 9,751,592.

In this embodiment, as best shown in FIG. 4, the anchor 104 also has an anchor electrical element 150 configured to contact the fixture electrical element 135. As can be seen, in this embodiment, the anchor electrical element 150 is connected to the anchor base 130, namely being disposed on a lower surface of the anchor base 130. Notably, this position of the anchor electrical element 150 ensures that it will come into contact with the fixture electrical element 135. It is contemplated that the anchor electrical element 150 may be positioned differently depending on the position of the fixture electrical element 135. In this embodiment, the anchor electrical element 150 includes a plurality of spring-loaded pins 152 made of an electrically conductive material (e.g., copper). In this example, four spring-loaded pins 152 are provided, each being positioned to contact a corresponding one of the electrical contacts 137 of the anchor fixture 102. In particular, the spring-loaded pins 152 are aligned to form a row with similar spacing as the electrical contacts 137 of the anchor fixture 102.

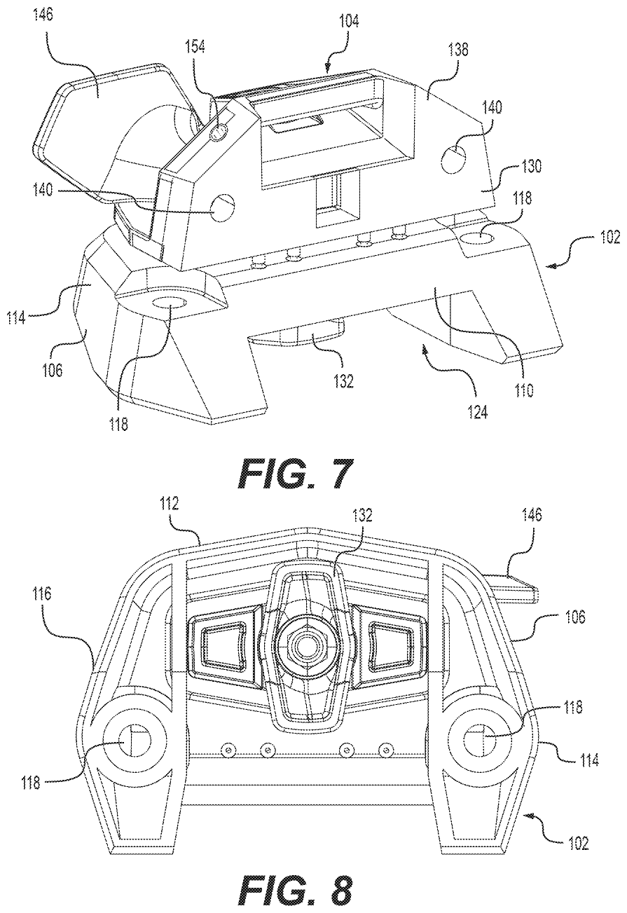

As shown in FIG. 7, the anchor 104 also has an anchor power connector 154 configured to electrically connect the anchor 104 to the accessory 75. In particular, the anchor power connector 154 is electrically connected to the spring-loaded pins 152 in order to conduct electricity between the spring-loaded pins 152 and the accessory 75. In this embodiment, the anchor power connector 154 is a power receptacle configured for receiving a power plug that is electrically connected to the accessory 75 via wiring 156 (FIG. 2). It is contemplated that, in other embodiments, the anchor power connector 154 could be hardwired instead of selectively receiving the power plug (i.e., the wiring 56 is fixedly attached to the anchor 104 to electrically connect the anchor 104 to the accessory 75).

In order to secure the anchor 104 to the anchor fixture 102, the anchor lock 132 is placed in the unlocked position as shown in FIGS. 3 and 4 and the anchor lock 132 is then inserted through the anchor aperture 122 and into the anchor chamber 120 of the anchor fixture 102. Upon doing so, the anchor electrical element 150 comes into contact with the fixture electrical element 135. The anchor lock 132 is then rotated relative to the anchor fixture 102 to the locked position, shown in FIGS. 5 to 8, whereby the anchor lock 132 is disposed in the anchor chamber 120 and prevented by the anchor fixture 102 from passing through the anchor aperture 122. In the locked position, the pressure exerted by the cams 133 on the anchor fixture 102 cause the spring-loaded pins 152 of the anchor electrical element 150 to retract as they are forced against the electrical contacts 137 of the anchor fixture 102. Electrical communication between the fixture electrical elements 135 and the anchor electrical element 150 is thus established. As such, since the anchor electrical element 150 is electrically connected to the accessory 75 while the fixture electrical element 135 is electrically connected to the power source 145, the accessory 75 is electrically connected to the power source 145 via the anchor 104 and the anchor fixture 102.

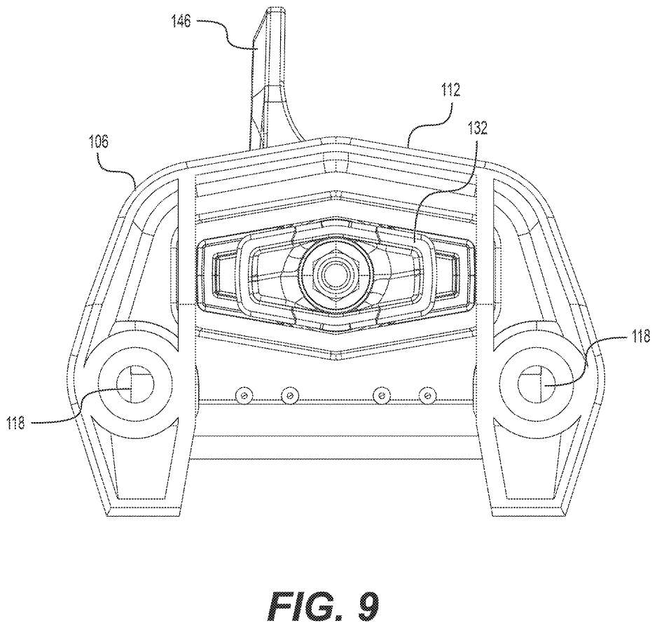

In order to disconnect the anchor 104 from the anchor fixture 102, the anchor lock 132 is placed in the unlocked position whereby, as best shown in FIG. 9, the anchor lock 132 is free to pass through the anchor aperture 122. Upon moving the anchor lock 132 to the unlocked position, the spring-loaded pins 152 are withdrawn as they cease being forced inward by the electrical contacts 137. The anchor 104 is then lifted to extract the anchor lock 132 from the anchor chamber 120 through the anchor aperture 122.

It is contemplated that, in other embodiments, the roles of the anchor 104 and the anchor fixture 102 may be reversed. Notably, in some embodiments, the anchor fixture 102 could be connected to the accessory 75 (rather than the snowmobile 10), and the anchor 104 could be connected to the snowmobile 10 (rather than the accessory 75). For instance, in such embodiments, the anchor fixture 102 and the anchor 104 may be electrically connected to the accessory 75 and the power source 145 respectively.

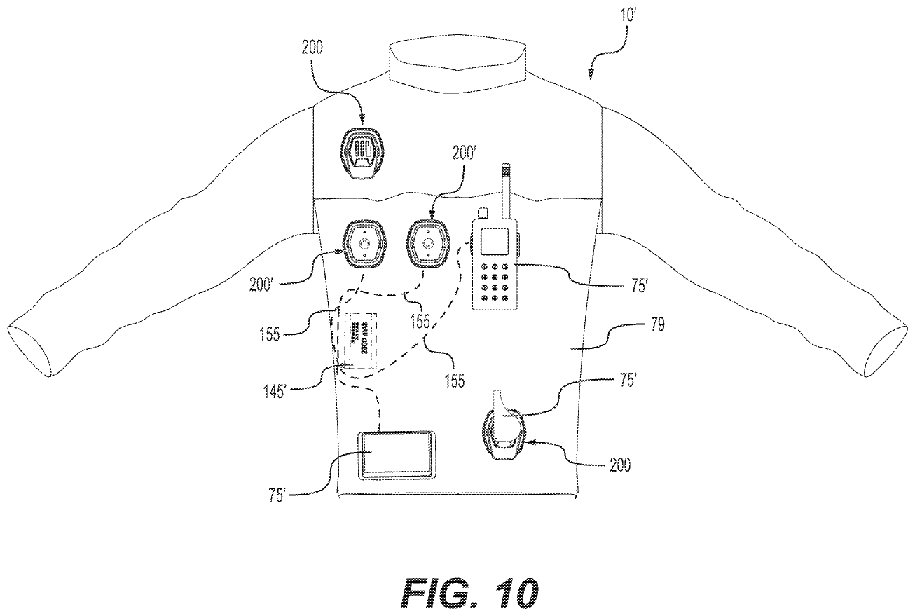

With reference now to FIG. 10, another embodiment of a system 200 for connecting an accessory 75′ to an item 10′ will be described herein. In this embodiment, the item 10′ is a soft item such as textile-based item. In particular, the item 10′ is a garment and specifically a jacket. However, the garment 10′ may be any other type of garment in other embodiments (e.g., a pair of pants, a personal floatation device, etc.). In other examples, the item 10′ may be another type of soft item (e.g., a duffle bag).

The system 200 includes an anchor fixture 202 that is fixable to the garment 10′, and an anchor 204 that is mateable with the anchor fixture 202. In this embodiment, the anchor fixture 202 is connected to a textile body 79 of the garment 10′ while the anchor 204 is connected (fixedly or removably) to the accessory 75′. The accessory 75′ may be any suitable accessory for fixing to the garment 10′. For example, as illustrated in FIG. 10, the accessory 75′ can be a communication device (e.g., a walkie-talkie), an electronic navigation device, or a whistle. Other types of accessories are also contemplated.

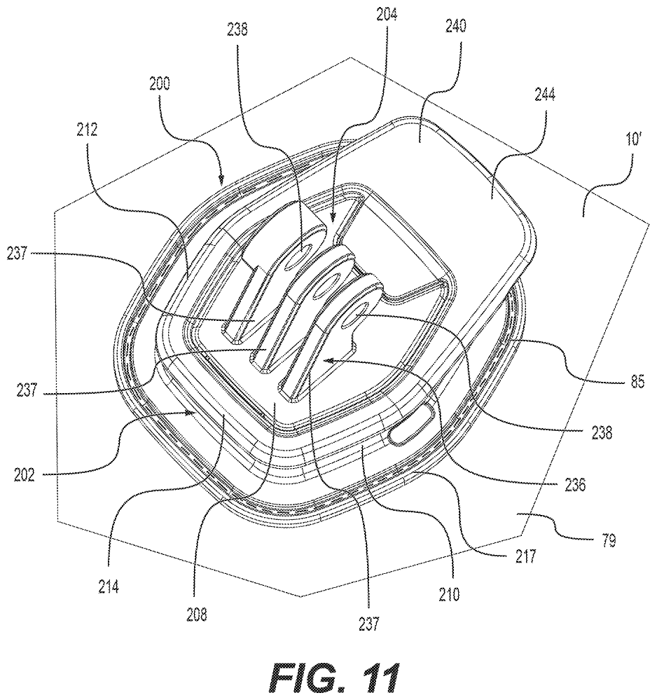

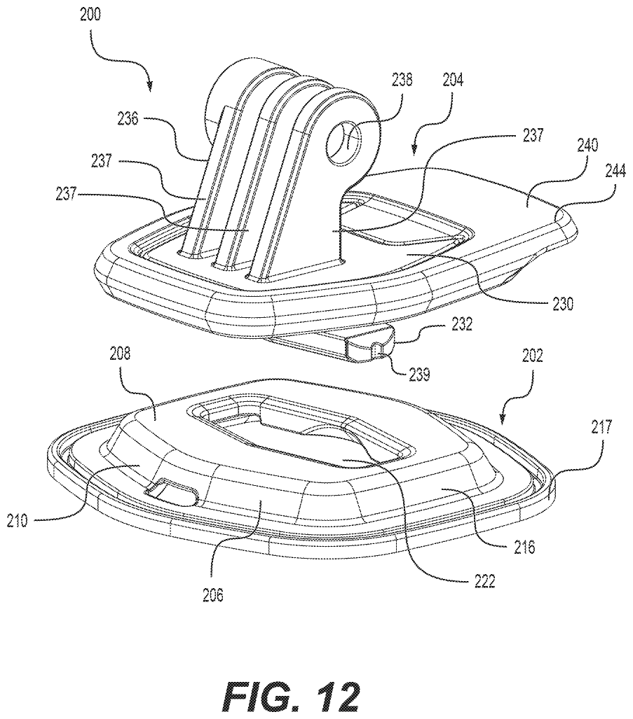

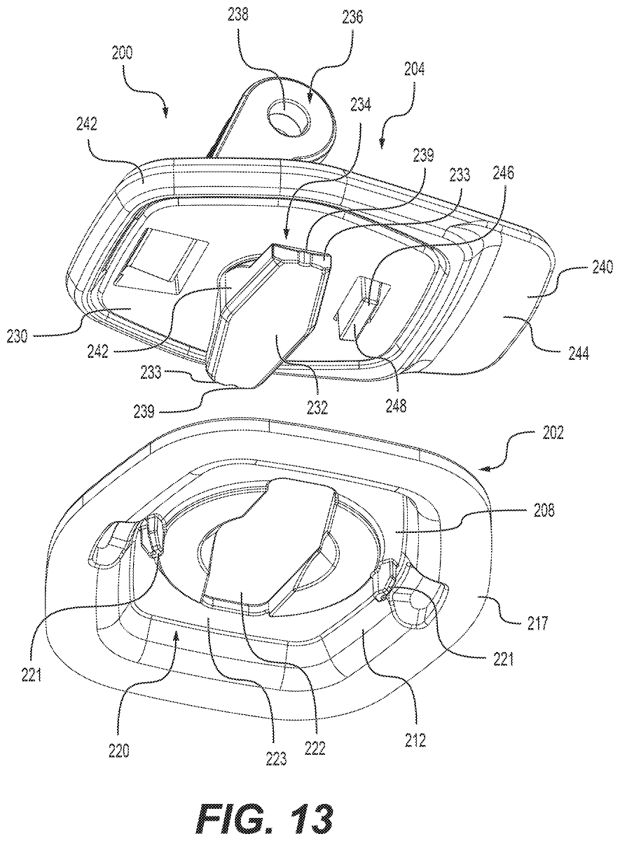

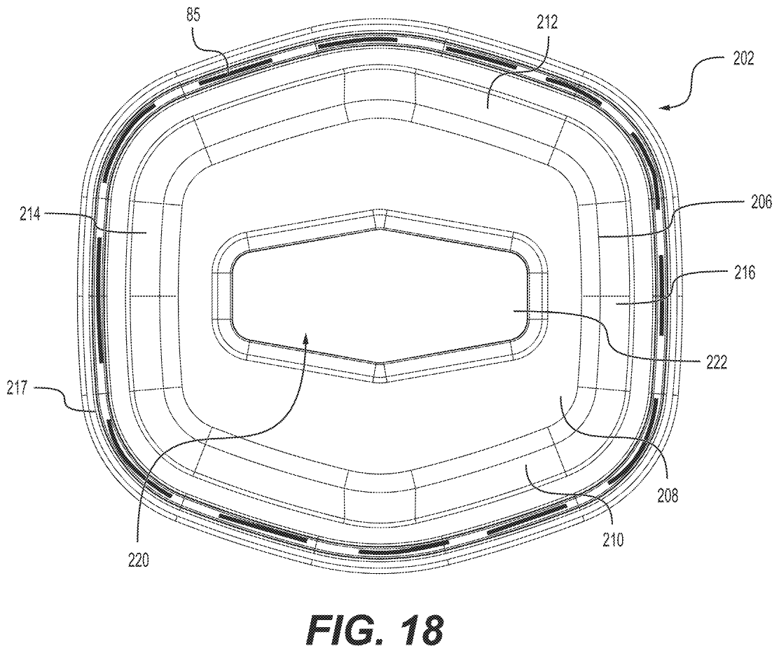

With reference to FIGS. 12 and 13, in this embodiment, the anchor fixture 202 has a fixture body 206 including a top wall portion 208, a front wall portion 210, a rear wall portion 212, a left side wall portion 214 and a right side wall portion 216. Each of the wall portions 208, 210, 212, 214, 216 has an interior surface and an exterior surface. The anchor fixture 202 also has an edge portion 217 that is configured to be fastened to the textile body 79 of the garment 10′. The edge portion 217 is connected to and surrounds a periphery of the fixture body 206 such that the edge portion 217 defines a periphery of the anchor fixture 202. The edge portion 217 may only extend along a portion of the periphery of the fixture body 206 in other embodiments. In this embodiment, the edge portion 217 is made of a soft material which can be helpful to fix the edge portion 217 to the textile body 79. For example, the edge portion 217 may be made of a textile material or an elastomeric material. As such, as best shown in FIGS. 11 and 18, the edge portion 217 can be sewn to the textile body 79 via stitching 85. It is contemplated that the stitching 85 may be replaced by any other fastening connection. For example, the edge portion 217 could instead be glued to the textile body 79.

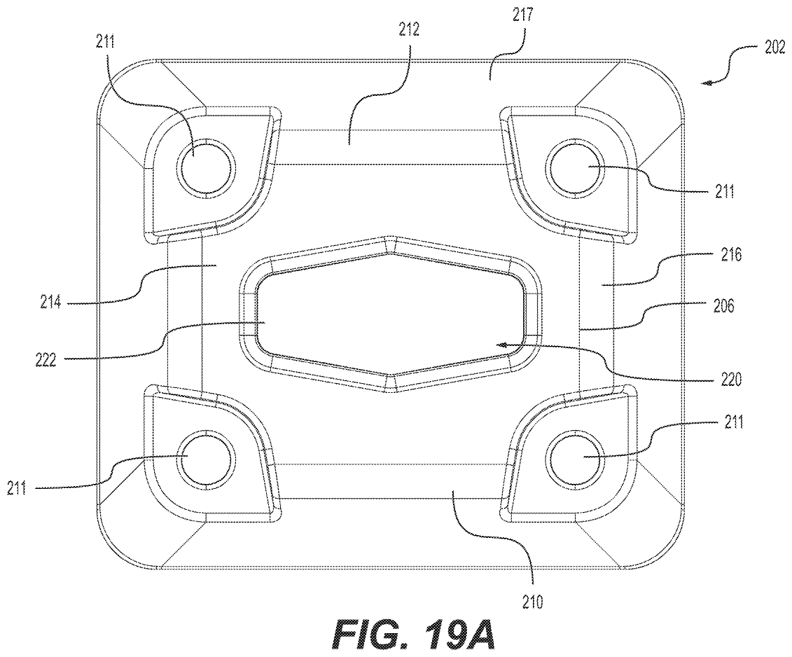

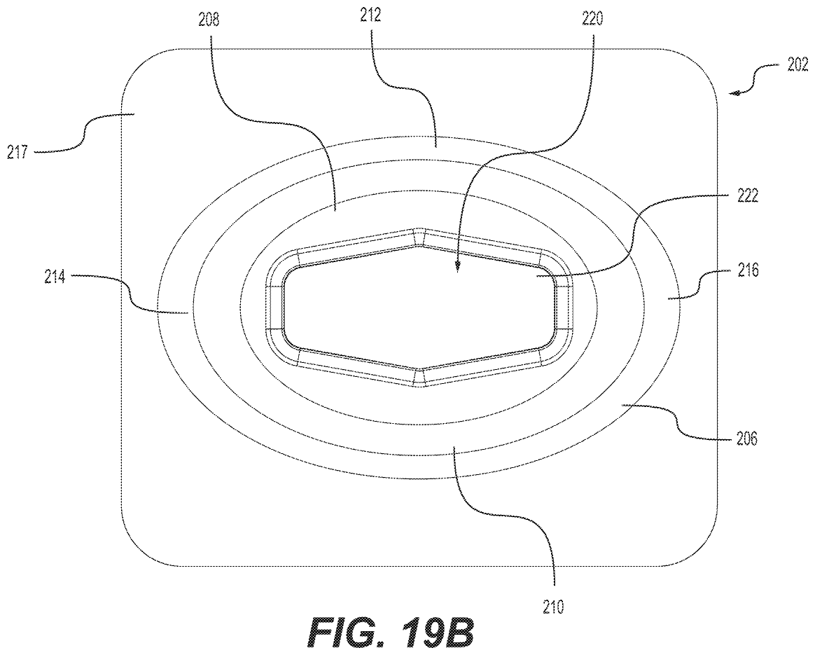

In an alternative embodiment, as shown in FIG. 19A, the anchor fixture 202 could be configured to be otherwise connected to the item 10′. For instance, in this alternative embodiment, the entire anchor fixture 202 is made integrally as a single piece component from a continuous material (e.g., plastic). Thus, in this example, the edge portion 217 forms part of the fixture body 206. In this alternative embodiment, the top wall portion 208 of the fixture body 206 defines four openings 211 which are configured to receive respective fasteners (e.g., bolts, rivets or screws) for fixing the anchor fixture 202 to the item 10′. In another alternative embodiment, as shown in FIG. 19B, the entire anchor fixture 202 is made integrally as a single piece component and the edge portion 217 is configured to be overmolded onto the item 10′. This may be useful for example if at least part of the item 10′ is made by molding such that, upon molding the item 10′, the anchor fixture 202 is overmolded by the material forming the item 10′.

Returning to FIG. 13, the interior surfaces of the wall portions 208, 210, 212, 214, 216 define an anchor chamber 220 that, as will be described in more detail below, is configured to receive therein a part of the anchor 204. The top wall portion 208 also defines an anchor aperture 222 that opens into the anchor chamber 120. As will be described below, part of the anchor 204 is inserted into the anchor chamber 220 through the anchor aperture 222 in order to secure the anchor 204 to the anchor fixture 202. In this embodiment, the fixture body 206 is generally dome-shaped thereby having a concave bottom side and a convex top side, the anchor chamber 220 being defined on the concave bottom side. In use, when the anchor fixture 202 is affixed to the textile body 79, the anchor chamber 220 is thus defined between the surface of the textile body 79 and the wall portions 208, 210, 212, 214, 216. Notably, as shown in FIG. 18, the stitching 85 that affixes the anchor fixture 202 to the textile body 79 surrounds the anchor chamber 220.

As shown in FIG. 13, in this embodiment, the anchor fixture 202 also has two inner interlocking members 221 configured to interlock with a part of the anchor 204 as will be described in greater detail further below. In particular, the interlocking members 221 are protrusions that extend downward from an interior surface 223 of the top wall portion 208. Each interlocking member 221 has a curved portion 225 facing inwardly toward the anchor aperture 222.

Turning now to the anchor 204, with reference to FIGS. 12 and 13, in this embodiment, the anchor 204 has an anchor base 230 and an anchor lock 232 extending below the anchor base 230, spaced therefrom by a gap 234. The anchor base 230 is configured to be connected to a body of the accessory 75′. Notably, the anchor base 230 has an accessory mount 236 that is configured for connection to the body of the accessory 75′. In this embodiment, the accessory mount 236 includes three stands 237 projecting upward from a top surface of the anchor base 230. Each of the stands 237 defines an opening 238. The openings 238 are aligned with one another (i.e., are coaxial) and are configured to receive a fastener (not shown) that engages the accessory 75′. In particular, in this embodiment, the accessory 75′ has two stands defining respective openings and received between the stands 237. The fastener is inserted through the stands 237 and through the stands of the accessory 75′. The accessory 75′ can be made to pivot or not about the fastener by adjusting the tightness with which the fastener is secured (a tighter fastening more greatly limits pivoting of the accessory 75′ about the fastener). The accessory mount 236 may be configured differently in other embodiments.

As best shown in FIG. 13, the anchor lock 232 is connected to the anchor base 230 via a stem 242 defining an axis (not shown). The stem 242 extends downward from the anchor base 230. The anchor lock 232 includes two cams 233 extending from opposite sides of the stem 242 in opposite directions from each other. In this embodiment, each of the cams 233 defines a recess 239 at an end of the cam 233. The recesses 239 are configured to receive respective ones of the interlocking members 221 as will be described in more detail below. As will be appreciated, unlike the anchor 104 described above, in this embodiment, the anchor 204 does not have a lever to rotate the anchor lock 232. Rather, the anchor base 230 and anchor lock 232 move together. As such, when the anchor lock 232 is rotated between an unlocked position and a locked position, as will be explained further below, the anchor base 230 describes the same rotation. Therefore, the entirety of the anchor 204 is rotated in order to rotate the anchor lock 232 between the unlocked and locked positions.

As shown in FIGS. 12 and 13, in this embodiment, the anchor 204 also has a movable latch 240 that is operable by the user to keep the anchor lock 232 in the locked position when it is disposed within the anchor chamber 220. The latch 240 has a latch body 242 that is connected to and surrounds the anchor base 230. The latch body 242 may only extend along a part of the periphery of the anchor base 230 in other embodiments. In this embodiment, the latch body 242 includes a handle 244 for handling by the user to actuate the latch 240. As shown in FIG. 13, the latch 240 has a latching feature 246 for engaging the anchor fixture 202 to prevent rotation of the anchor lock 232 from the locked position to the unlocked position as will be described in greater detail below. In this embodiment, the latching feature 246 includes a latching protrusion 248 that is selectively insertable within the anchor aperture 222. The handle 244 is operatively connected to the latching protrusion 248 via the latch body 242 such that lifting and lowering the handle 244 causes the latching protrusion 248 to be lifted and lowered accordingly. The manner in which the latching protrusion 248 interacts with the anchor fixture 202 will be described in more detail below.

In this embodiment, the latch 240 is made of an elastomeric material (e.g., rubber). It is contemplated that the latch 240 could be made of other materials in other embodiments.

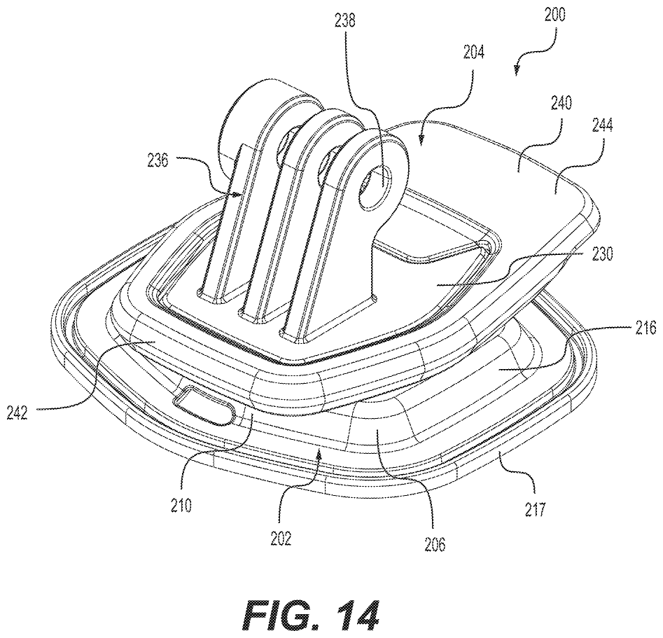

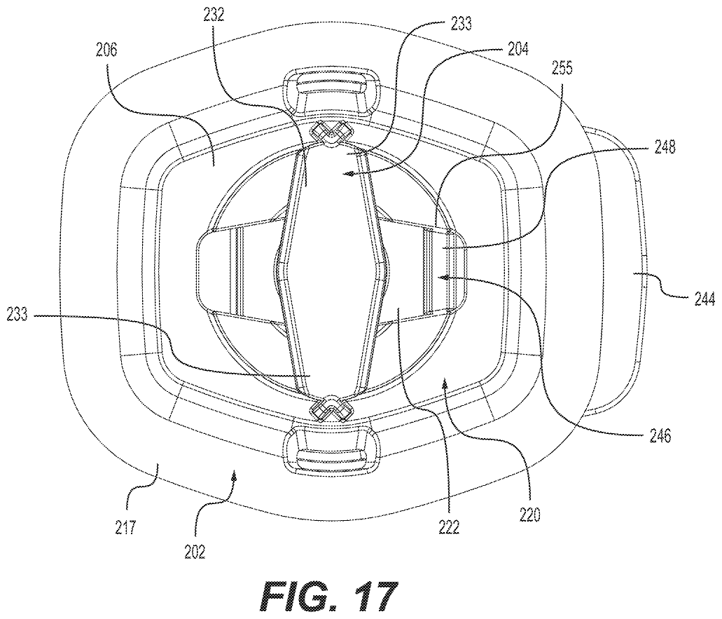

In order to secure the anchor 204 to the anchor fixture 202, the anchor 204 is first oriented such that the anchor lock 232 is in the unlocked position as shown in FIGS. 12 and 13. The anchor lock 232 is then inserted through the anchor aperture 222 and into the anchor chamber 220 of the anchor fixture 202. The anchor lock 232 is thus disposed in the anchor chamber 220 but is still in the unlocked position and thus free to pass through the anchor aperture 222, as illustrated for example in FIG. 14. The entirety of the anchor 204 is then rotated in order to rotate the anchor lock 232 to the locked position, as shown in FIG. 17. As will be appreciated, since the anchor 204 is fixed to the accessory 75, the accessory 75 is rotated together with the anchor 204 when the anchor 204 is rotated between the unlocked and locked positions. As shown in FIG. 17, in the locked position, the anchor lock 232 is disposed in the anchor chamber 220 and prevented by the anchor fixture 202 (namely by the top wall portion 208) from passing through the anchor aperture 222. In this embodiment, when the anchor lock 232 is rotated to the locked position, the interlocking members 221 of the anchor fixture 202, which are fixed and disposed within the anchor chamber 220, engage the cams 233 of the anchor lock 232. More specifically, the curved portion 225 of each interlocking member 221 is received in a corresponding recess 239 of one of the cams 233. The anchor lock 232 thus snaps into place when the curved portions 225 are moved into the recesses 239.

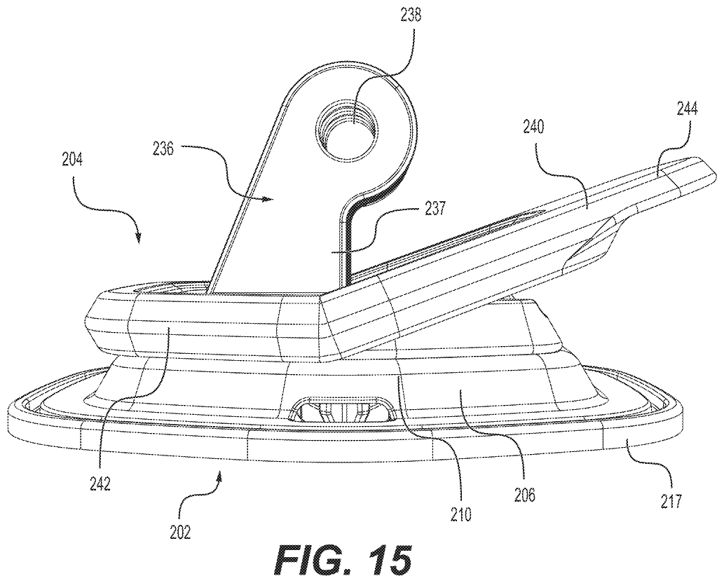

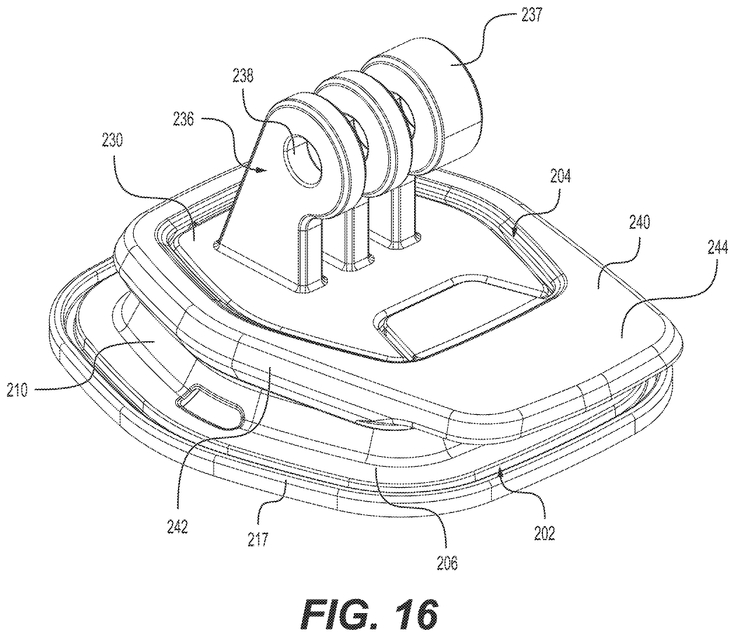

At this point, the anchor 204 is in the position shown in FIG. 15, with the latch handle 244 being lifted such that the latching protrusion 248 is not in engagement with the anchor fixture 202. As shown in FIGS. 16 and 17, in order to further secure the anchor lock 232 in the locked position, the user lowers the handle 244 which causes the latching protrusion 248 to be inserted into the anchor aperture 222. As shown in FIG. 17, the latching protrusion 248 is shaped and dimensioned such that, when it is inserted into the anchor aperture 222, the latching protrusion 248 is in contact with part of an inner edge portion 255 of the top wall portion 208 defining the anchor aperture 222 such as to wedge the anchor lock 232 in the locked position. As such, the latching protrusion 248 thereby prevents the anchor lock 232 from moving to the unlocked position. This may be helpful to ensure that the anchor lock 232 remains in the locked position even when it is subjected to significant vibrations (e.g., if the user is wearing the garment 10′ while driving a snowmobile). It is contemplated that, in other embodiments, an aperture defined by the anchor fixture 202 and different from the anchor aperture 222 could receive the latching protrusion 248.

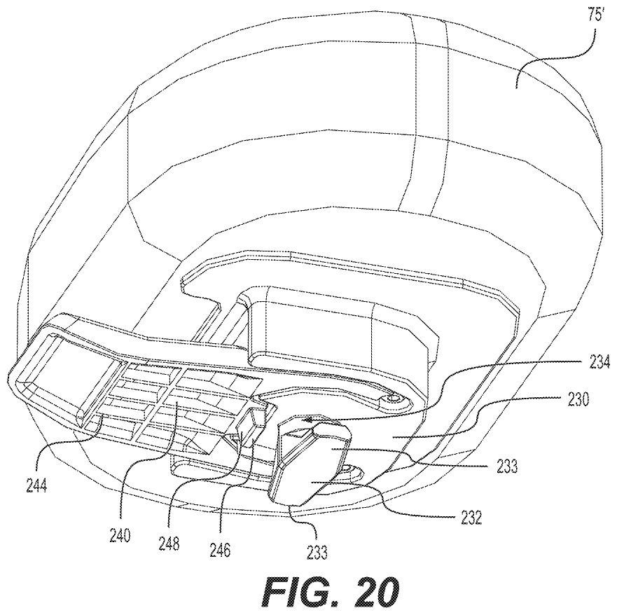

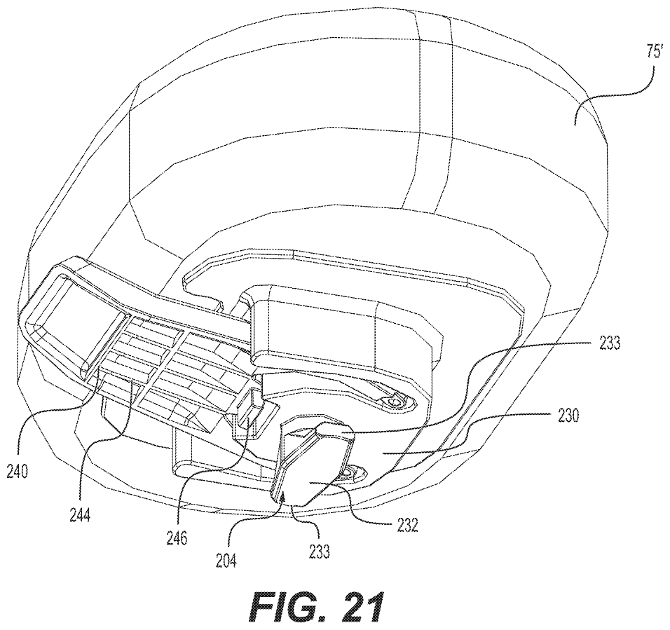

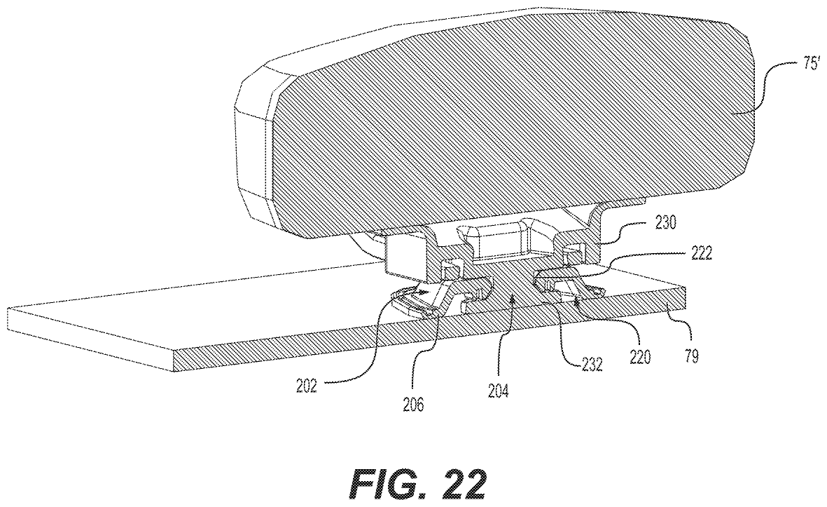

The anchor 204 may also be configured differently in other embodiments. For instance, an alternative embodiment of the anchor 204 attached to the accessory 75′ is illustrated in FIGS. 20 to 22. In this embodiment, the anchor 204 does not include the stands 237 described above. Instead, the anchor base 230 is connected to the accessory 75′ via fasteners and/or glue, or the anchor base 230 could be molded onto a bottom of the body of the accessory 75′. In addition, as can be seen, the handle 244 of the latch 240 extends further outwards from the anchor base 230 to accommodate the size of the accessory 75′.

It is contemplated that, in other embodiments, the anchor 204 may be instead be connected to the textile body 79 of the garment 10′ while the anchor fixture 202 is connected to the accessory 75′. For instance, in such embodiments, the anchor 204 could have an edge portion similar to the edge portion 217 described above with respect to the anchor fixture 202.

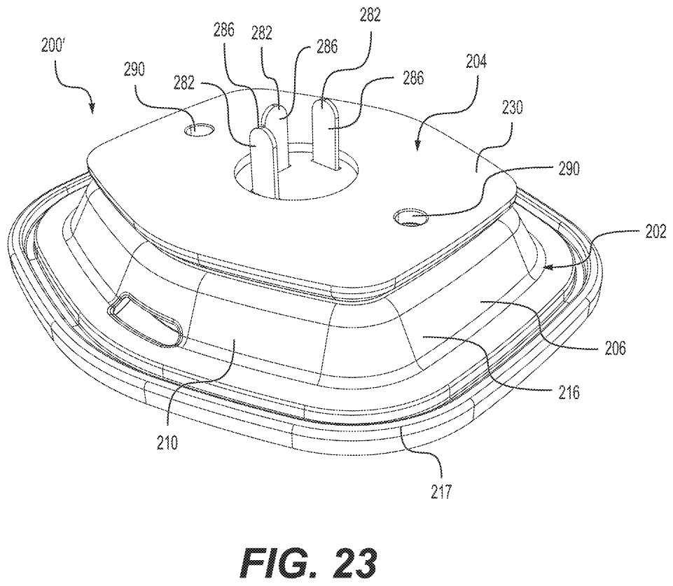

Referring back to FIG. 10, according to another embodiment, a system 200′ is provided that is similar to the system 200 described above. Therefore, in FIGS. 23 to 28 which illustrated the system 200′, the same reference numbers as used in the description of the system 200 have been used to designate equivalent components of the system 200′. Only the differences between the system 200′ and the system 200 will thus be described herein. As will be explained below, one of the main differences between the systems 200, 200′ is that the anchor fixture 202 and the anchor 204 of the system 200′ are configured to be electrically connected to one another in order to power the accessory 75′.

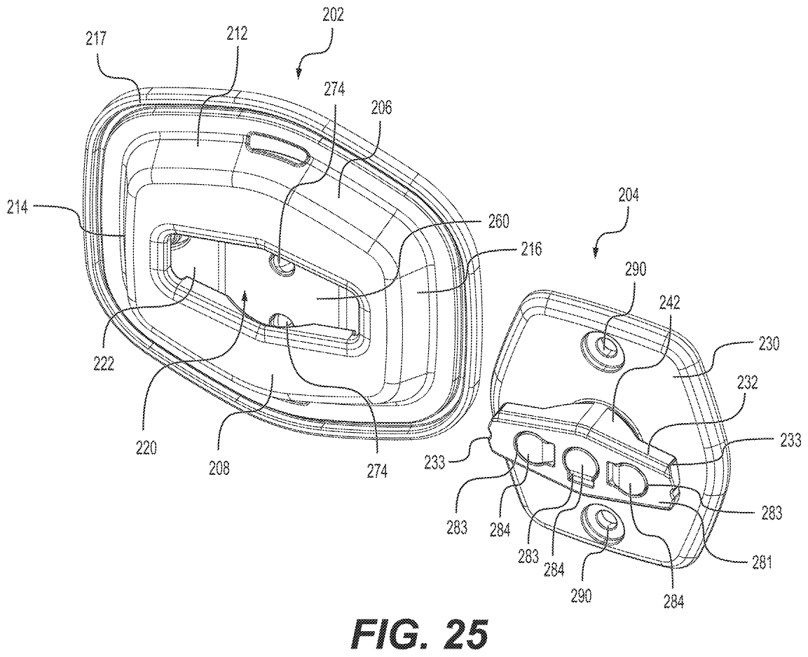

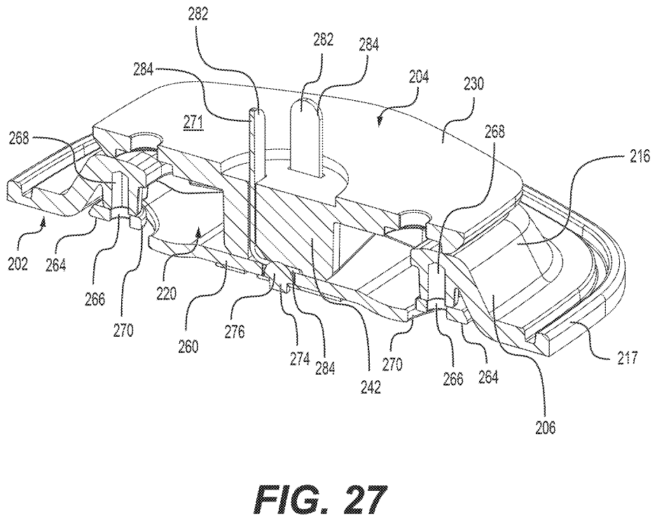

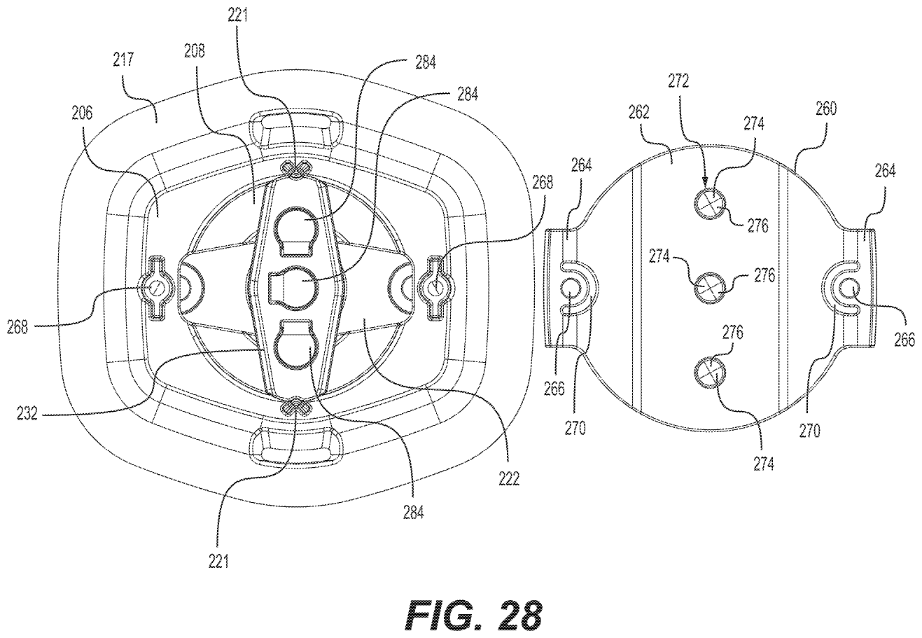

With reference to FIGS. 25 to 28, in this embodiment, the anchor fixture 202 of the system 200′ includes a backing member 260 connected to the fixture body 206. Together with the wall portions 208, 210, 212, 214, 216 of the fixture body 206, the backing member 260 defines the anchor chamber 220. That is, at least part of the anchor chamber 220 is defined between the backing member 260 and the fixture body 206. As best shown in FIG. 28, the backing member 260 has a body 262 which, in this example, is generally circular. It is contemplated that the body 262 may have any other suitable shape in other embodiments. In this embodiment, the body 262 defines two flange portions 264 on opposite sides of the body 262 configured for connection to the fixture body 206. Notably, the flange portions 264 define respective openings 266 for receiving fasteners (not shown) that connect the backing member 260 to the fixture body 206. In particular, the fasteners extend through the openings 266 and into respective openings 268 (FIGS. 27, 28) defined by the fixture body 206. The openings 268 are threaded to securely receive the fasteners therein. As shown in FIGS. 27 and 28, in this embodiment, the body 262 of the backing member 260 also defines two semi-circular slots 270 that partially surround respective ones of the openings 266. The semi-circular slots 270 afford some flexibility to the flange portions 264.

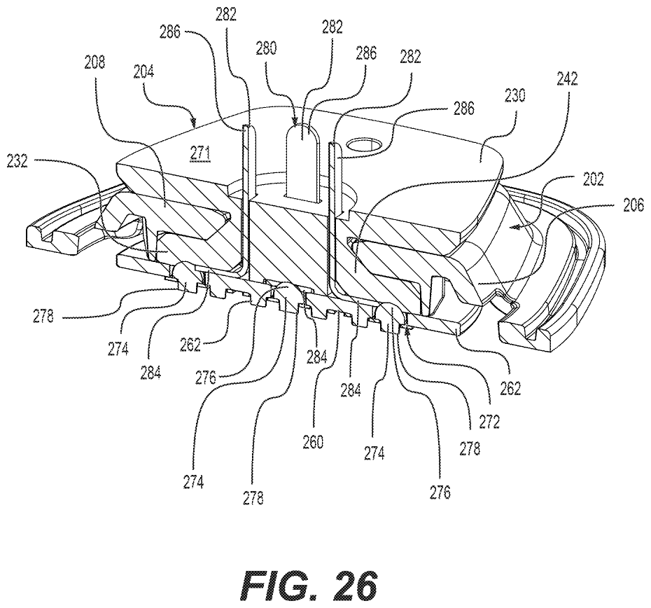

As shown in FIGS. 26 to 28, the backing member 260 also has a fixture electrical element 272 that is configured to electrically connect the anchor fixture 202 to the anchor 204 as will be described in more detail below. In this embodiment, the fixture electrical element 272 includes three electrical contacts 274 that are arranged in a row and. Each of the electrical contacts 274 has a dome-shaped contact portion 276 and a connecting portion 278 extending below the contact portion 276. The contact portion 276 protrudes from a top surface of the body 262 of the backing member 260. As such, the contact portion 276 is disposed within the anchor chamber 220. The connecting portion 278 is configured to be electrically connected to a power source 145′ (FIG. 10). Notably, as shown in FIG. 10, wiring 155 connects each of the anchor fixture 202 of the systems 200′ to the power source 145′ which is supported by the textile body 79 of the garment 10′. In this embodiment, the power source 145′ is a portable battery pack. It is contemplated that the power source 145′ could be any other suitable power source in other embodiments.

Referring now to FIGS. 23 to 25, the anchor 204 of the system 200′ has an anchor electrical element 280 that is configured to contact the fixture electrical element 272. In this embodiment, the anchor electrical element 280 includes three conducting members 282 that extend at least partly through the anchor base 230 and through the anchor lock 232. Notably, as best shown in FIG. 25, each of the conducting members 282 has a contact portion 284 that is exposed at a lower surface 281 of the anchor lock 232. In particular, the lower surface 281 of the anchor lock 232 defines three openings 283 in which the contact portions 284 of the conducting members 282 are disposed. In this embodiment, the contact portions 284 are formed by bending of the conducting members 282 which provides the contact portions 284 with a certain flexibility to deflect upon coming into contact with the electrical contacts 274. As best shown in FIGS. 26 and 27, from the anchor lock 232, the conducting members 282 extend upwardly through the stem 242 of the anchor 204 and protrude from a top surface 271 of the anchor base 230. In particular, each of the conducting members 282 has a connecting portion 286 that protrudes upward from the top surface 271 of the anchor base 280. The connecting portion 286 is configured to conduct electricity to a power circuit of the accessory 75′. Notably, the connecting portions 286 form three prongs that are receivable by corresponding receptacles defined by the accessory 75′.

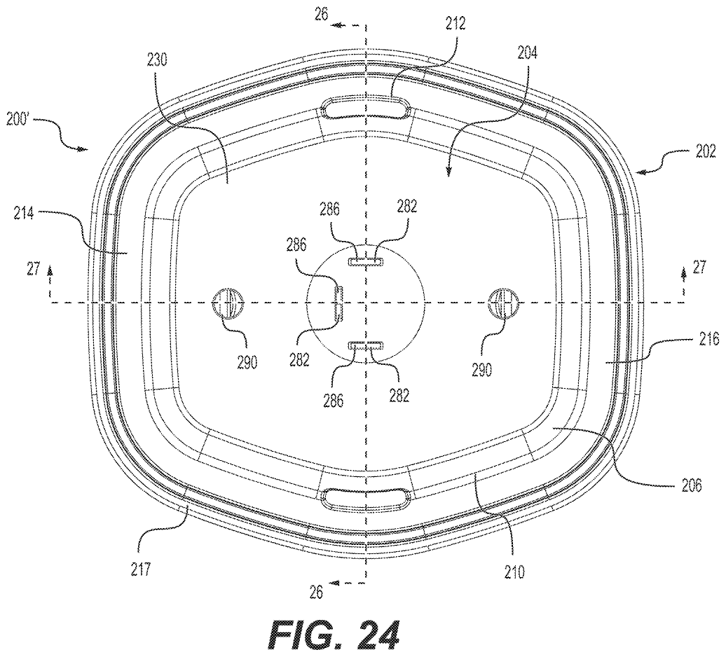

As will be appreciated, in this embodiment, the accessory mount 236 previously described is omitted. Rather, the accessory base 230 is connected to the accessory 75′ via fasteners (not shown) received by openings 290 (FIGS. 23, 24) defined by the anchor base 230. The anchor 204 may be connected to the accessory 75′ in any other suitable way.

In order to secure the anchor 204 to the anchor fixture 202 of the system 200′, the anchor 204 is first oriented such that the anchor lock 232 is in the unlocked position. The anchor lock 232 is then inserted through the anchor aperture 222 and into the anchor chamber 220 of the anchor fixture 202. The anchor lock 232 is thus disposed in the anchor chamber 220 but is still in the unlocked position and thus free to pass through the anchor aperture 222. The entirety of the anchor 204 is then rotated in order to rotate the anchor lock 232 to the locked position, shown in FIGS. 26 to 28. As will be appreciated, since the anchor 204 is fixed to the accessory 75′, the accessory 75′ is rotated together with the anchor 204 when the anchor 204 is rotated between the unlocked and locked positions. In the locked position, the anchor lock 232 is disposed in the anchor chamber 220 and prevented by the anchor fixture 202 (namely by the top wall portion 208) from passing through the anchor aperture 222. Upon doing so, the anchor electrical element 280 comes into contact with the fixture electrical element 272. Notably, the contact portions 276, 284 are aligned and come into contact with one another to establish electrical communication therebetween. As such, since the anchor electrical element 280 is electrically connected to the accessory 75′ while the fixture electrical element 272 is electrically connected to the power source 145′, the accessory 75′ is electrically connected to the power source 145′ via the anchor 204 and the anchor fixture 202.

Similarly to the system 200, the roles of the anchor 204 and the anchor fixture 202 may be reversed in other embodiments, with the anchor 204 connected to the textile body 79 and the anchor fixture 202 connected to an accessory body of the accessory 75′.

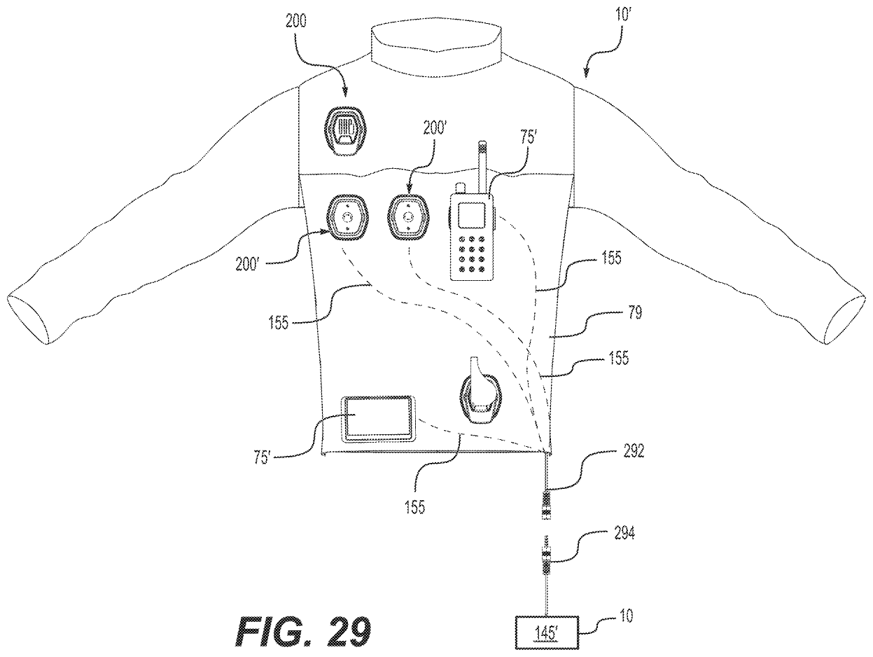

With reference to FIG. 29, according to an alternative embodiment, the power source 145′ may be external to the garment 10′. Notably, in this alternative embodiment, the wiring 155 electrically connects the anchor fixtures 202 of the various systems 200′ to a garment power connector 292 of the garment 10′ that is configured to be mated with an external connector 294. In this embodiment, the garment power connector 292 is a receptacle and the external connector 294 is a plug that is received within the garment power connector 292. The external connector 294 is itself electrically connected to the power source 145′ which, in this alternative embodiment, is a battery of the snowmobile 10. Other types of power sources are also contemplated.

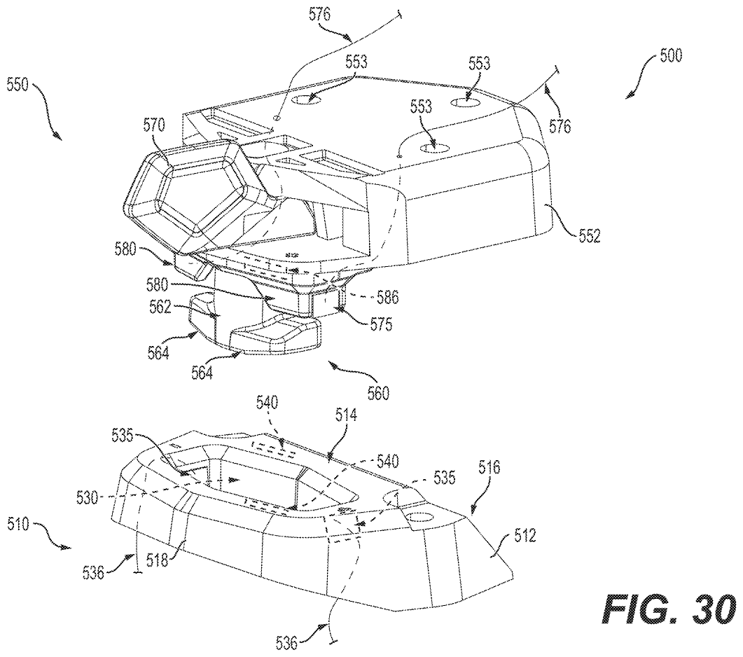

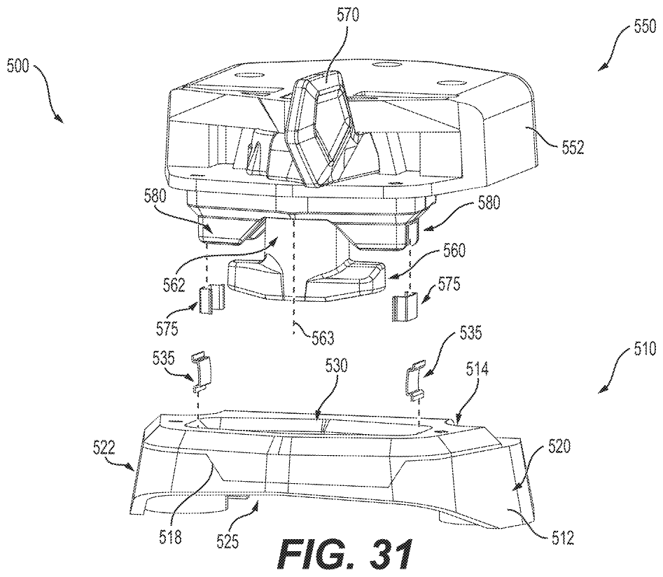

With reference to FIGS. 30 and 31, another non-limiting embodiment of a system 500 for connecting an accessory to an item is illustrated. The system 500 is configured to connect to a variety of accessories and items, including but not limited to the accessories and items described above.

The system 500 includes an anchor fixture 510 for connecting to the item and an anchor 550 for connecting to the accessory. As with the systems described above (such as the system 200), the anchor 550 selectively connects to the anchor fixture 510 in order to selectively connect the accessory to the item. As will be described in more detail below, the system 500 further serves to electrically connect the accessory to the item.

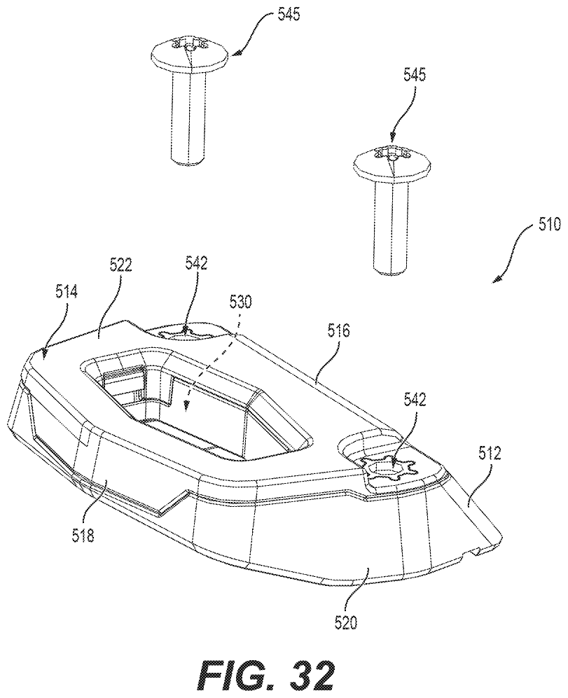

With additional reference to FIGS. 32 to 36, the anchor fixture 510 has a fixture body 512 configured to be connected to the item. In the present embodiment, the fixture body 512 has faster apertures 542 defined therein to receive fasteners 545 for fastening the anchor fixture 510 to the item. It is contemplated that the anchor fixture 510 could be differently connected to the item in different embodiments.

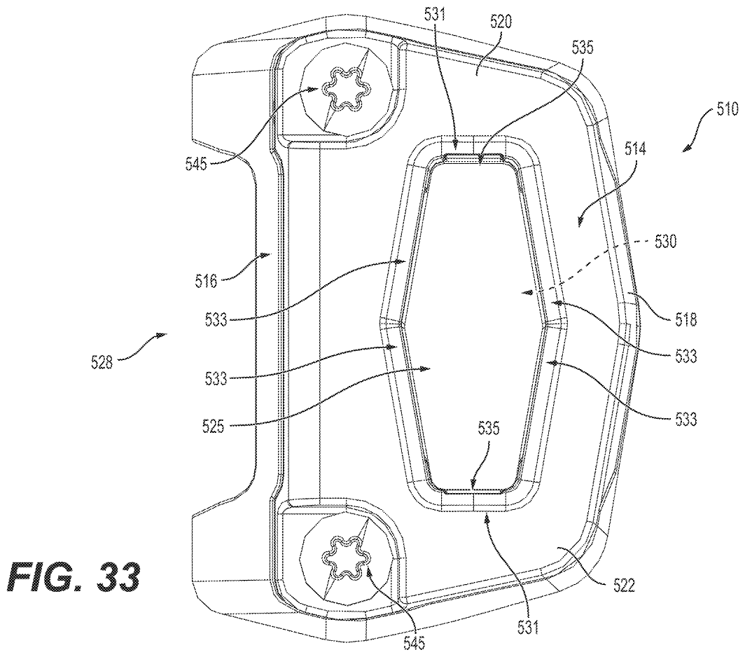

The fixture body 512 has a top wall portion 514, a front wall portion 516, a rear wall portion 518, a left side wall portion 520 and a right side wall portion 522. Each of the wall portions 514, 516, 518, 520, 522 has an interior surface and an exterior surface. The interior surfaces of the wall portions 514, 516, 518, 520, 522 define an anchor chamber 525 that is configured to receive therein a part of the anchor 550. The top wall portion 514 also defines an anchor aperture 530 that opens into the anchor chamber 525. As can be seen from FIG. 33, the anchor aperture 530 is a hexagonal aperture 530 in the present embodiment. The hexagonal aperture 530 is defined by two shorter end side portions 531 and four longer longitudinal side portions 533. Each of the two end side portions 531 are shorter than each of the four longitudinal side portions 533. It is contemplated that the shape of the anchor aperture 530 could vary in different embodiments.

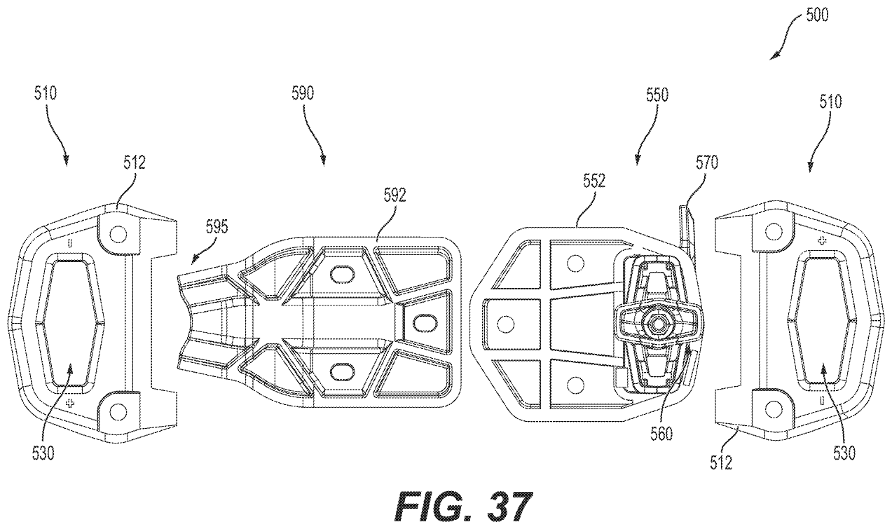

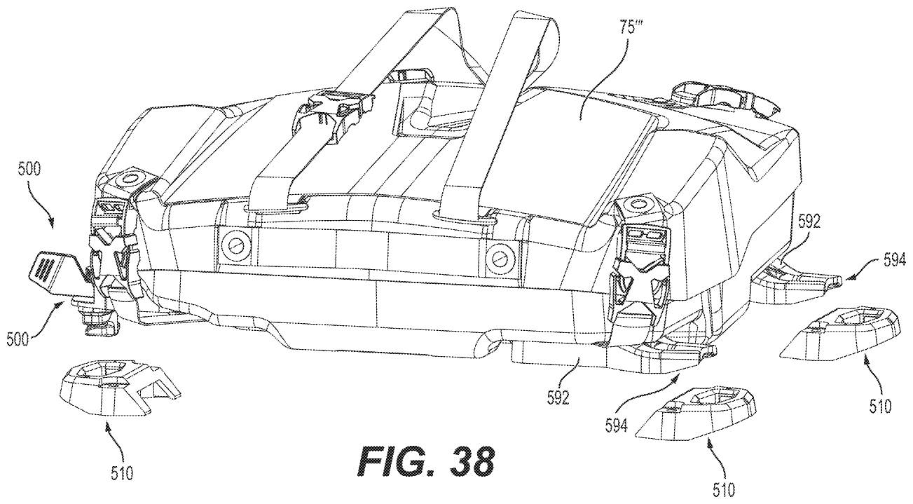

In this embodiment, the front portion 516 also defines a tongue aperture 528 that opens into the anchor chamber 525. It is contemplated that the tongue aperture 528 could be omitted in other embodiments. The tongue aperture 528 can be optionally used for inserting a toe-in portion of a tongue fastener therein, thereby providing another way in which to secure an accessory to the anchor fixture 510. See for example in FIGS. 37 and 38, where an accessory 75″ includes both the anchor 550 and a plurality of tongue fasteners 592 with toe-in portions 594. The accessory 75″ is thus connectable to an item, such as the snowmobile 10, having a corresponding number of anchor fixtures 510.

According to this embodiment, the anchor fixture 510 also includes an electrical element connected to the fixture body 512. Specifically, the anchor fixture 510 includes a pair of electrical contacts 535 connected to the fixture body 510. The electrical contacts 535 are disposed along the surface of the fixture body 512 defining the anchor aperture 530, specifically on opposite lateral sides thereof. Each electrical contact 535 is disposed on one of the two end side portions 531 along the shorter sides of the hexagonal aperture 530. Different positioning of the electrical contacts 535 is contemplated.

The electrical contacts 535 include a positive contact plate and a negative contact plate, although the particular arrangement of the polarity of the contacts 535 is not meant to be particularly limited. The electrical contacts 535 are configured to be connected to one or more electrical components, for instance a power source of the item to which the anchor fixture 510 is connected. The power source connection is schematically illustrated in FIG. 30 by leads 536 (wires) connecting out from the anchor fixture 510, although it is contemplated that the electrical connections may be different than wires extending from the anchor fixture 510. The electrical contacts 535 are configured and arranged to contact electrical contacts of the anchor 550 (described below) when the anchor 550 is connected to and/or in contact with the anchor fixture 510.

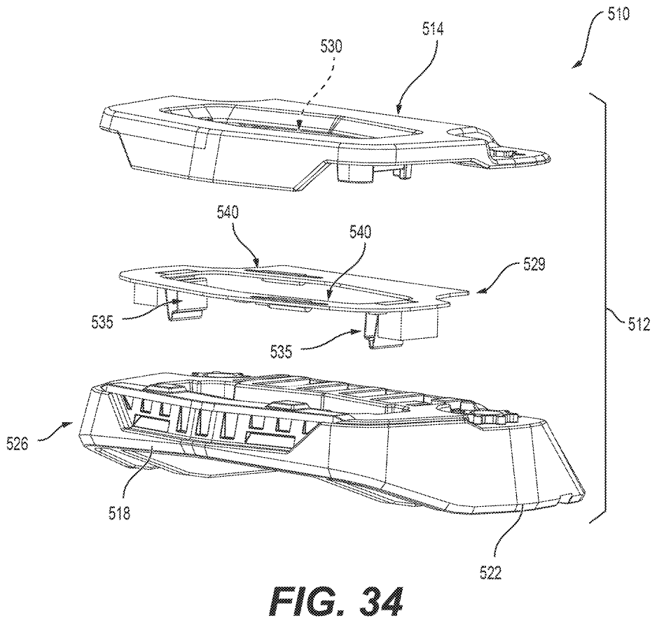

As is illustrated in FIG. 34, the fixture body 512 is formed from a base body portion 526 and a cap body portion 527 in the present embodiment. The base body portion 526 and a cap body portion 527 are snap fitted together, but it is contemplated that different connection methods could be used, including by fastening or gluing. The fasteners 545 further aid in maintaining the cap body portion 527 in position on the base body portion 526 in the present embodiment.

The fixture body 512 also includes a printed circuit board (PCB) 529 disposed in the fixture body 512, between the base body portion 526 and a cap body portion 527. The electrical contacts 535 are operatively connected to the PCB 529, the PCB 529 being configured to manage operation of the electrical contacts 535 when in use. The leads 536 provide power to the electrical contacts 535 via the PCB 529. The PCB 529 includes additional components to provide proper management of power flow through the item and the anchor fixture to the anchor 550 and the accessory. The components of the PCB 529 include but are not limited to: fuses to protect against overcurrent, overvoltage, double-polarity, short circuits; and an output voltage regulator. It is noted, for example, that the regulator is included in at least some embodiments to ensure that an even voltage (such as 12V) is provided to the accessory, especially in cases where the originating power source is a vehicle magneto or alternator, where the actual voltage can range up to 14.5V during operation.

The anchor fixture 510, and more specifically the PCB 529, further includes at least one switch 540 operatively connected to the electrical contacts 535. As will be described in further detail below, the switch 540 is configured to change polarity of the electrical contacts 535 in response to an orientation of the anchor 550 connected to the anchor fixture 510.

Returning to FIGS. 30 and 31, the anchor 550 has an anchor base 552 and an anchor lock 560 extending below the anchor base 552, spaced therefrom by a gap. The anchor base 552 is configured to be connected to a body of the accessory. The anchor lock 560 is configured to be inserted through the anchor aperture 530 of the anchor fixture 510. In this embodiment, the anchor base 552 defines three fastener openings 553 for receiving respective fasteners (not shown) that engage the body of the accessory such as to connect the anchor base 552 to the accessory. The number of fastener openings 552 could vary in different embodiments.

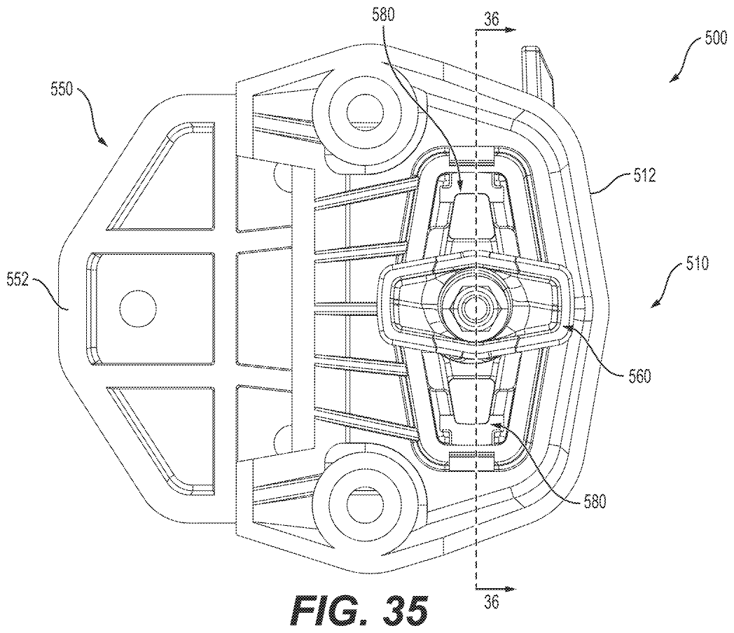

The anchor lock 560 is connected to the anchor base 552 via a stem 562 defining an axis 563. The anchor lock 560 includes two cams 564 extending from opposite sides of the stem 562 in opposite directions from each other. A lever 570 is connected to the stem 562, extending generally horizontally from the anchor base 552. The lever 570 allows a user to rotate the stem 562 about the axis 563, thereby rotating the anchor lock 560. In particular, the anchor lock 560 is rotatable about the axis 563 between locked and unlocked positions. In the unlocked position, illustrated in FIGS. 30 and 31, the anchor lock 560 extends generally parallel to the anchor base 552 such that the cams 564 are offset from one another in a direction orthogonal to the stem 562. As such, in the unlocked position, the anchor lock 560 is free to pass through the anchor aperture 530 of the anchor fixture 510. In the locked position, illustrated in FIG. 35, the anchor lock 560 is rotated by 90° about the axis 563 relative to the unlocked position. As such, in the locked position, the anchor lock 560 is prevented by the anchor fixture 510 from passing through the anchor aperture 510 and the anchor lock 560 is disposed in the anchor chamber 525. Additional description of a similar structure anchor can be found in U.S. Pat. No. 9,751,592.

In the present embodiment, the anchor base 552 includes an electrical element, specifically a pair of electrical contacts 575. The electrical contacts 575 include a positive contact plate and a negative contact plate, although the particular arrangement of the polarity of the contacts 575 is not meant to be particularly limited. The electrical contacts 575 are configured to be connected to one or more electrical components, for instance powered components of the accessory to which the anchor 550 is connected. The electrical component connection is schematically illustrated in FIG. 30 by leads 576 (wires) extending out from the anchor 550, although it is contemplated that the electrical connections may be different than wires extending from the anchor 550. The electrical contacts 575 are configured and arranged to contact the electrical contacts 535 to electrically connect the anchor fixture 510 to the anchor 550 when the anchor 550 is connected to the anchor fixture 510.

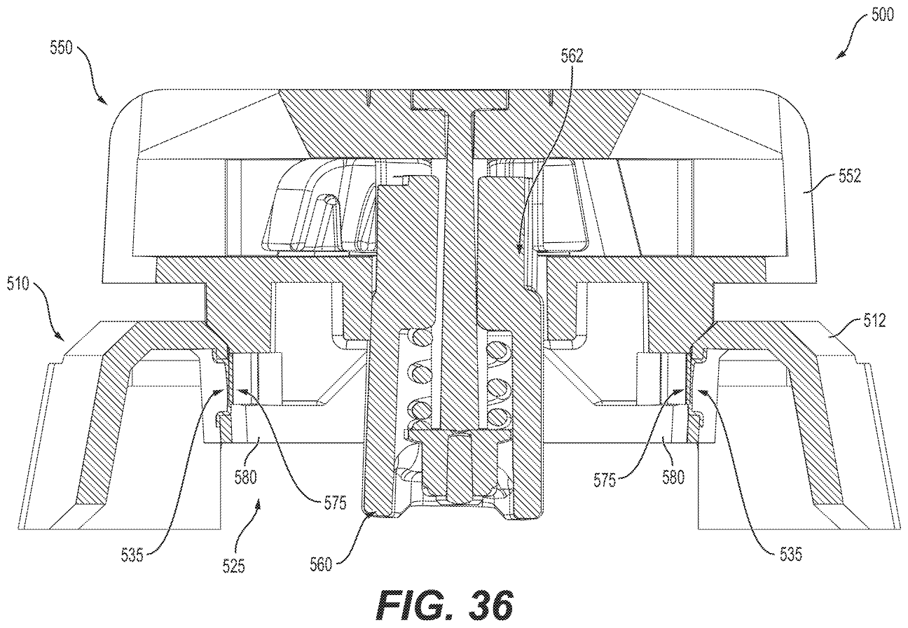

The anchor 550 specifically includes a contact portion 580 extending from the anchor base 552 in a same direction as the anchor lock 560. The contact portion 580 is shaped and arranged to be disposed in the anchor aperture 530 when the anchor lock 560 is selectively inserted in the anchor fixture 510. The electrical contacts 575 are disposed on the contact portion 580, such that the electrical contacts 575 are located inside the surfaces of the anchor aperture 530 when the anchor lock 560 is disposed in the chamber 525. As can be seen in FIGS. 35 and 36, the electrical contacts 575 of the anchor 550 are in contact with the electrical contacts 535 when the contact portion 580 is inserted into the anchor aperture 530. It is contemplated that the lever 570 could be omitted in some embodiments, for example in cases where the contact portions 580 are shaped and arranged for providing a push fit connection between the anchor 500 and the anchor fixture 510.

As can be seen from the Figures, the anchor lock 560 and the anchor aperture 530 are shaped such that the anchor 550 could be connected to the anchor fixture 510 in two different orientations, one 180 degrees rotated from the other. In order to ensure the proper polarity of power flow when the anchor 550 is electrically connected to the anchor fixture 510, the anchor fixture 510 includes one or more switches 540 and the anchor 550 includes one or more position indicators for causing activation or deactivation of the switche(s) 540, depending on the relative orientation. Specifically, the anchor 550 includes a magnetic contact 586 (generally a magnet 586) disposed on or in the anchor body 552. The switch 540 of the anchor fixture 510 is specifically a pair of magnetic switches 540 configured to permit operation of the electrical contacts 535 when activated by the magnetic contact 586.

While different types of switches are contemplated, the switches 540 includes one reed switch 540 disposed on a first side of the anchor aperture 530 and another reed switch 540 disposed on a second side of the anchor aperture 530. The reed switches 540 form part of an H-bridge (not shown) of the PCB 529 which permits the polarity of the contacts 535 to be reversed based on the orientation in which the anchor 550 is inserted into the anchor fixture 510 in order to provide the correct current polarity. The switches 540 are disposed on diagonally opposing corners of the anchor aperture 530. As such that the magnetic contact 586 is aligned with the one switch 540 when the anchor 550 is connected to the anchor fixture 510 in a first orientation and aligned with the other switch 540 when the anchor 550 is connected to the anchor fixture 510 in a second orientation, the switches 540 being configured to permit operation of the electrical contacts 535 with the predetermined correct polarity when activated by the magnetic contact 586 depending on the orientation.

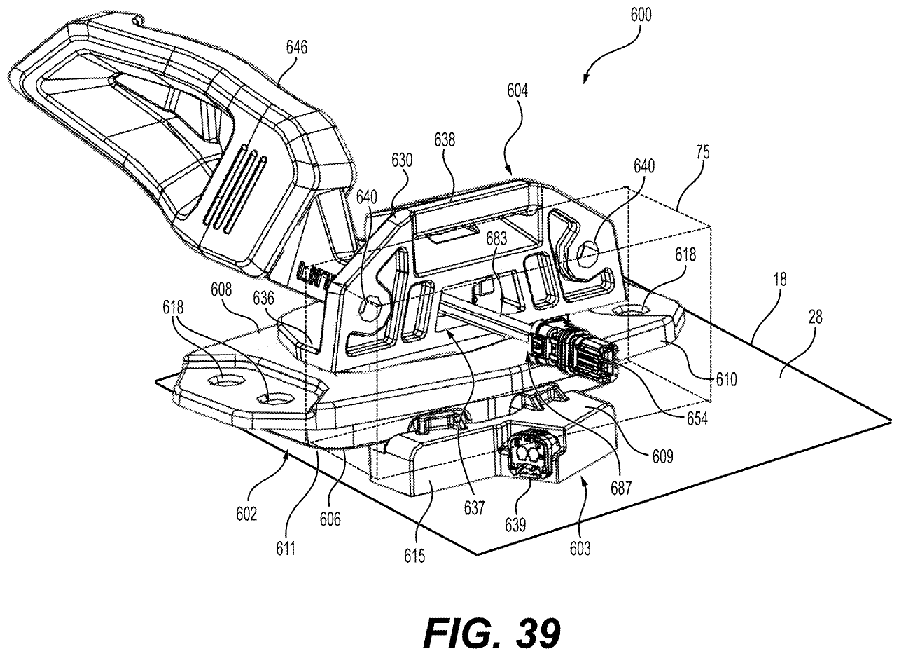

With additional reference to FIG. 39, a system 600 is broadly provided for connecting an accessory 75 (shown schematically) to an item such as a part of a vehicle 10 (as depicted in FIG. 1). It is contemplated that, in other embodiments, the item may instead be a textile-based item, such as a garment or any other type of soft item (e.g., a duffle bag).

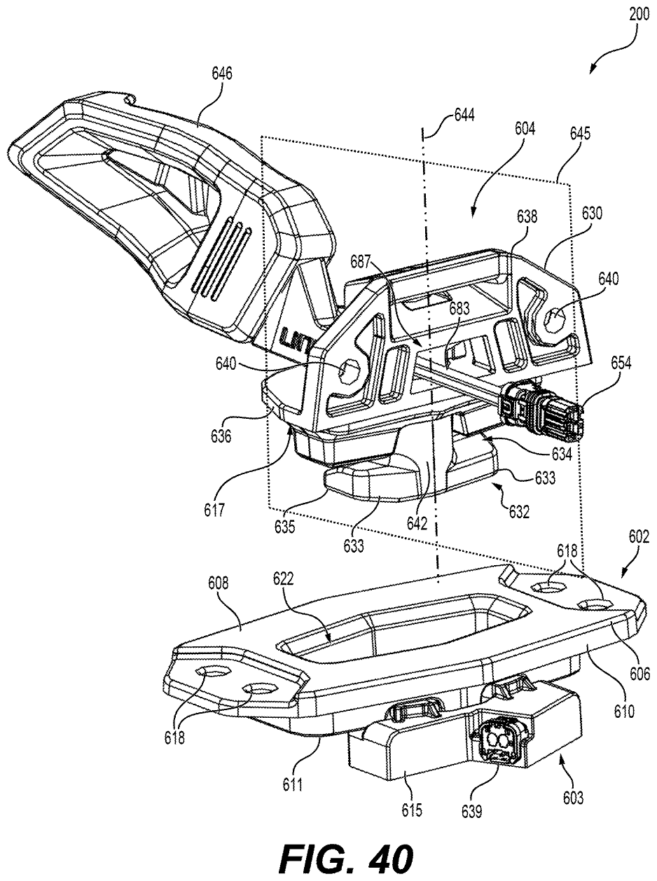

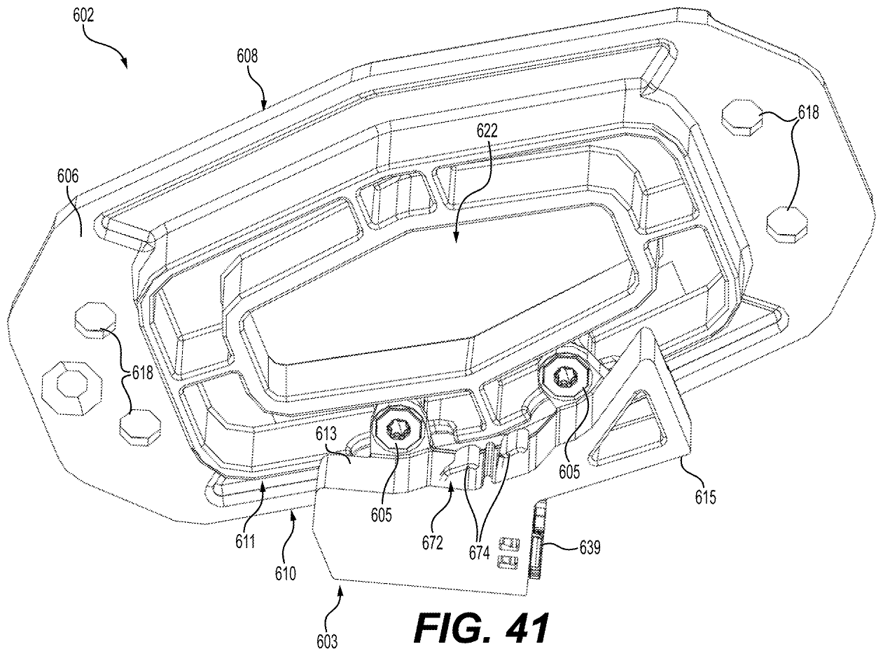

With reference to FIGS. 39 and 40, the system 600 includes an anchor fixture 602 that is connectable to the snowmobile 10, and an anchor 604 that is mateable with the anchor fixture 602. The anchor fixture 602 can be connected to any suitable part of the snowmobile 10. For instance, in this embodiment, the anchor fixture 602 is connected to an upper surface 28 (shown schematically in FIG. 39) of the tunnel 18. The anchor fixture 602 may be connected to another part of the snowmobile 10 in other embodiments (e.g., an accessory-receiving rack or other structure).

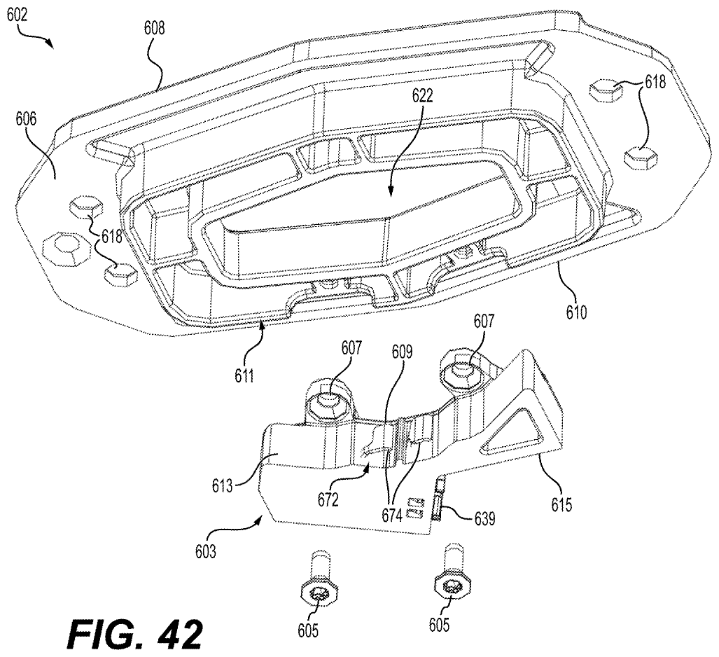

With reference to FIGS. 40 to 43, the anchor fixture 602 will now be described in detail. The fixture body 606 defines openings 618 for receiving respective fasteners (such as bolts) to connect the anchor fixture 602 to the upper surface 28 the tunnel 18. In the present embodiment, the fixture body 606 defines a pair of openings 618 on each respective lateral portion (that is, a left portion and a right portion) of the fixture body 606. It is contemplate that the number and positioning of openings 618 may vary. It is further contemplated that the anchor fixture 602 may be connected to the upper surface 28 the tunnel 18 using other suitable connecting mechanism, for example using inter-engageable portions.

The anchor fixture 602 has a fixture body 606 including a top wall portion 608 (sometimes referred to as the top surface) and a bottom surface 611. The fixture body 606 defines an anchor aperture 622 which extends between the top wall portion 608 and the bottom surface 611. In the present embodiment, the anchor aperture is hexagonal, but other shapes are contemplated. As will be described below, a part of the anchor 604 is inserted into the anchor aperture 622.

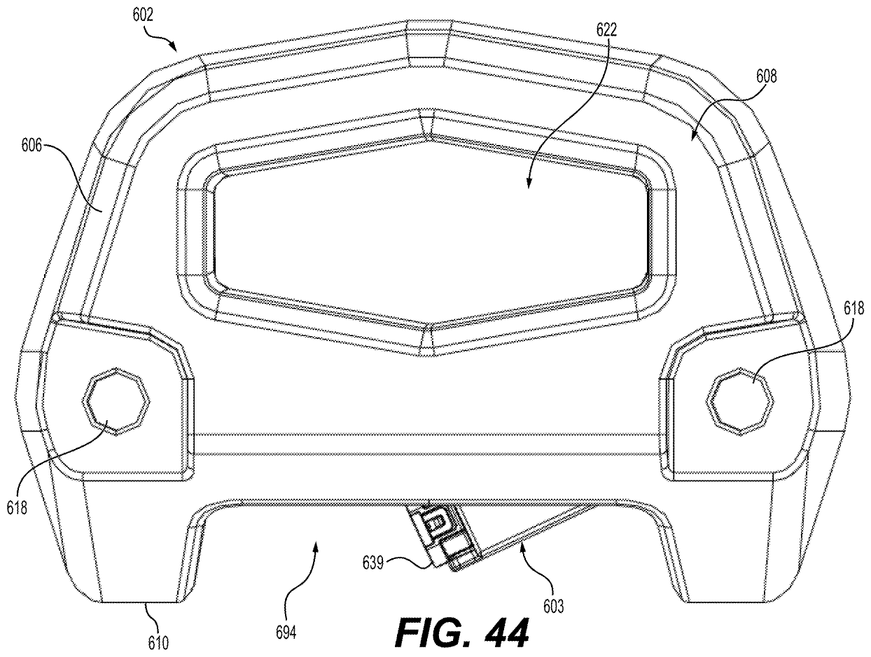

As depicted in FIG. 44, in an alternative embodiment, the fixture body 606 defines a recessed portion 694 extending inwardly from an outer edge along a front wall portion 610 of the fixture body 606, thereby forming a toe-in portion of the fixture body 606. It is contemplated that, in other embodiments, the recessed portion 694 may extend inwardly from any other suitable side of the fixture body 606. Furthermore, in some embodiments such as those as depicted in FIGS. 39 to 42, the recessed portion 694 may be omitted.

Returning to the embodiment of FIGS. 40 to 43, the anchor fixture 602 further includes a connector portion 603. In the present embodiment, the connector portion 603 is removably connected to the fixture body 606, thereby providing flexibility to a user to connect or remove the connector portion 603 as needed, for example, when electrical connection is not required. Specifically, the connector portion 603 defines apertures 607 for receiving fasteners (such as bolts 605) to connect the connector portion 603 to the fixture body 606, which includes corresponding apertures (not separately labeled) for receiving the bolts 605. However, it is contemplated that the connector portion 603 may be removably connected to the fixture body 606 differently, such as using inter-engageable members. The connector portion 603 is removably connected to the bottom surface 611 of the fixture body 606. In this embodiment, a portion of a top surface 609 of the connector portion 603 abuts a corresponding portion of the bottom surface 611 of the fixture body 606 when the connector portion 603 is connected. When connected, the connector portion 603 is positioned on a frontal half of the fixture body 606. However, in other embodiments, the connector portion 603 may be removably connected to a different part of the fixture body 606. In alternative embodiments, the connector portion 603 may be fixedly connected to the fixture body 606 or integrally formed with the fixture body 606.

With reference to FIGS. 41 to 43, the connector portion 603 includes a fixture electrical element 672 (sometimes referred to as the first electrical element) for establishing electrical connection between the anchor fixture 602 and the anchor 604. The fixture electrical element 672 is disposed on a rear surface 613 of the connector portion 603 such that, when the connector portion 603 is connected, the fixture electrical element 672 is rearward facing, facing toward the anchor aperture 622 and is positioned below the bottom surface 611 of the fixture body 606. Other positions of the fixture electrical element 672 are contemplated in other embodiments.

In this embodiment, the fixture electrical element 672 includes a pair of fixture electrical contacts 674 made of an electrically conductive material (such as copper). The fixture electrical contacts 674 are disposed in a side-by-side configuration, that is, the fixture electrical contacts 674 are horizontally aligned with one another and laterally spaced apart from one another. It is contemplated that, any number of fixture electrical contacts 674 may be implemented. Further, it is contemplated that the fixture electrical contacts 674 may be arranged differently, for example vertically aligned and spaced apart from one another.

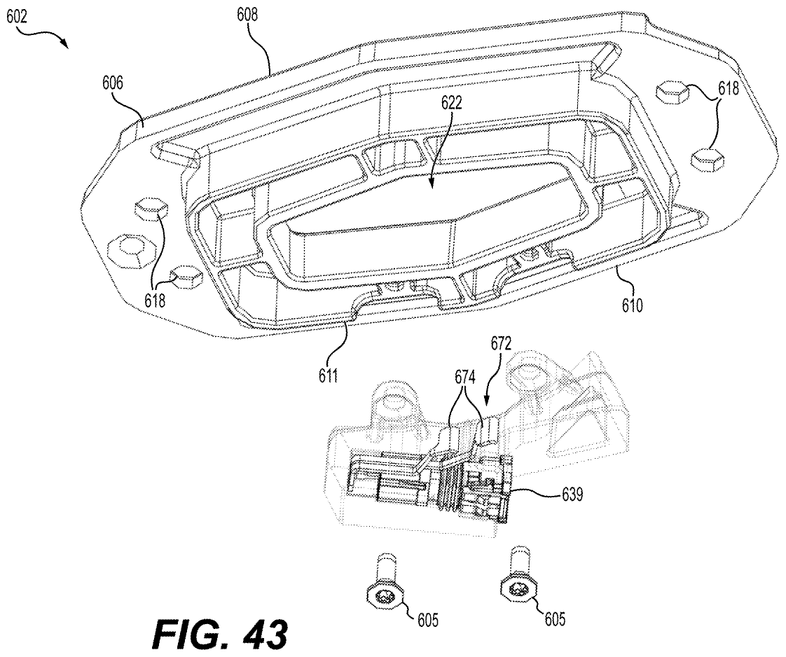

With reference to FIG. 43, the connector portion 603 further includes a fixture power connector 639 electrically connected to the pair of electrical contacts 674. The fixture power connector 639 is configured to electrically connect the anchor fixture 602 to the snowmobile 10. Specifically, in this embodiment, the fixture power connector 639 is configured to connect to a power source, such as a battery (not depicted) of the snowmobile 10, such that electricity is conducted between the electrical contacts 674 and the power source. In the present embodiment, the fixture power connector 639 is a power receptacle configured for receiving a power plug that is electrically connected to the power source via wiring. It is contemplated that, in other embodiments, the fixture power connector 639 may be hardwired instead of selectively receiving the power plug (i.e., wiring is fixedly attached to the connector portion 603 to electrically connect the anchor fixture 602 to the power source). In the present embodiment, the fixture power connector 639 extends from a front surface 615 of the connector portion 603, such that the fixture power connector 639 is opposite to the electrical contacts 674. The fixture power connector. It is contemplated that the fixture power connector 639 may be arranged differently in various embodiments.

With reference to FIGS. 40, 45, and 46, the anchor 604 will now be described in detail. The anchor 604 has an anchor base 630 and an anchor lock 632 connected to the anchor base 630. In the present embodiment, the anchor lock 632 extends below the anchor base 630, spaced therefrom by a gap 634. In this embodiment, the anchor base 630 includes a horizontal portion 636 and an upright portion 638 generally perpendicular to the upright portion 638. The upright portion 638 is configured to connect to the accessory 75. In this embodiment, the upright portion 638 defines fastener openings 640 for receiving fasteners (not depicted) to fasten the body of the accessory 75 to the anchor base 630.

The anchor lock 632 is configured to be inserted through the anchor aperture 622. The anchor lock 632 is connected to the anchor base 630 via a stem 642 defining a central axis 644. The anchor lock 632 defines a vertical plane 645 which contains and extends along the central axis 644. The anchor lock 632 includes two cams 633—each cam 633 extending away from opposite sides of the stem 642 in opposite directions from each other. In other words, each cam 633 is positioned on an opposite side of the vertical plane 645 of the anchor lock 632. In alternative embodiments, the number of cams 633 and positioning of the cams 633 on the stem 642 may vary. Upon insertion of the anchor lock 632 into the anchor aperture 622, a bottom face 617 of the anchor base 630 abuts, at least partially, the top wall portion 608, the stem 642 extends through the anchor aperture 622, and the cams 633 are disposed beneath the bottom surface 611 of the fixture body 606.

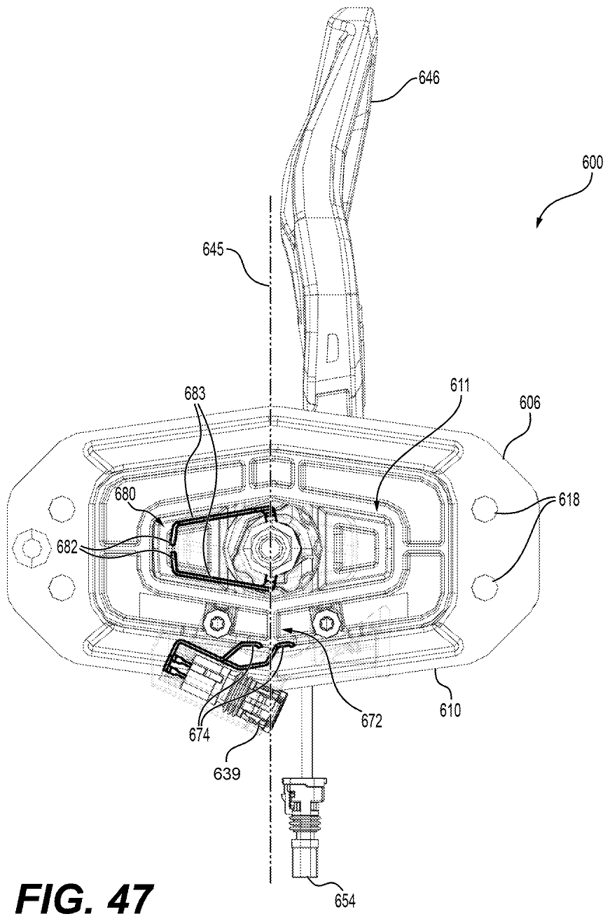

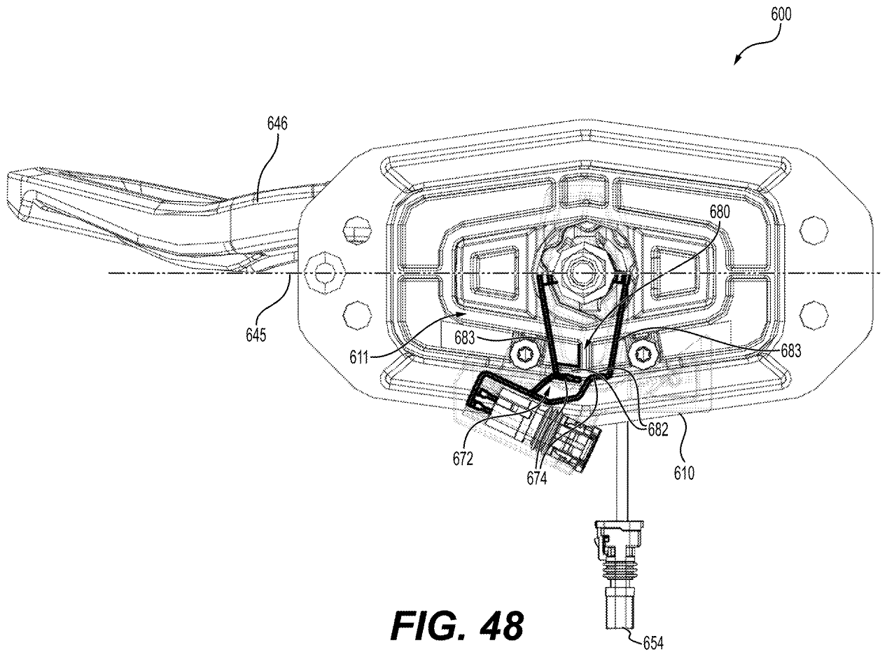

The anchor lock 632 is movable relative to the anchor fixture 602 such that the anchor lock 632 can move between a locked position and an unlocked position. In the present embodiment, the anchor lock 632 is rotatable about the central axis 644 relative to the anchor fixture 602. A lever 646 is connected to the stem 642 above the horizontal portion 636. The lever 646 allows a user to rotate the stem 642 about the central axis 644. Rotating the lever 646 causes rotation of the anchor lock 632, placing the anchor lock 632 in either the locked or unlocked position. In particular, the anchor lock 632 is rotatable about the central axis 644 between a locked position (depicted in FIG. 48) and an unlocked position (depicted in FIG. 47). In the unlocked position, the anchor lock 632 extends generally parallel to the anchor base 630 such that the cams 633 are offset from one another in a direction of elongation of the anchor base 630. In the unlocked position, the anchor lock 632 is free to pass through the anchor aperture 622, allowing the user to remove the anchor 604 from the anchor fixture 602. In the locked position, the anchor lock 632 is rotated 90° about the central axis 644 relative to the unlocked position. As a result, the cams 633—along with the vertical plane 645 defined by the anchor lock 632—are also rotated about the central axis 644. In the locked position, the cams 633 prevent the anchor lock 632 from passing through the anchor aperture 622, thereby securing the anchor 604 and the anchor fixture 602 to one another.

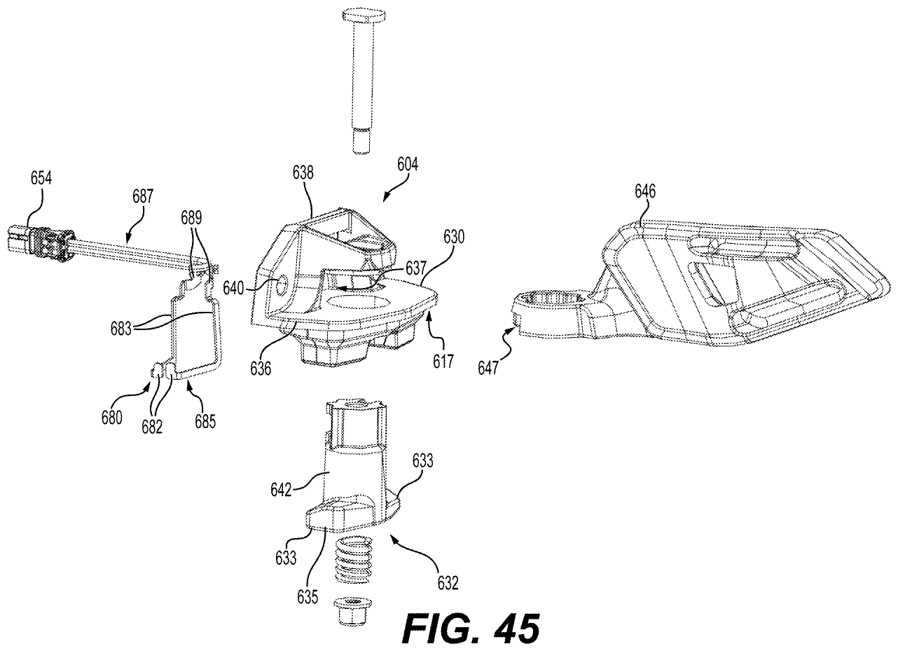

With reference to FIGS. 45 to 48, the anchor lock 632 includes an anchor electrical element 680 (sometimes referred to as a second electrical element). The anchor electrical element 680 is located on a lateral side of the anchor lock 632 (i.e., on one side of the vertical plane 645). In this embodiment, the anchor electrical element 680 is positioned on one of the cams 633, specifically, on a lateral face 635 of the cam 633 (FIG. 45). As depicted in FIG. 47, when the anchor lock 632 is in the unlocked position, the anchor electrical element 680 is rotationally offset from the fixture electrical element 672 (i.e., by 90°), resulting in no contact and electrical connection between the anchor electrical element 680 and the fixture electrical element 672. Upon rotation of the anchor lock 632 to the locked position, the anchor electrical element 680 and the fixture electrical element 672 are brought into contact with one another, thereby electrically connecting the anchor electrical element 680 and the fixture electrical element 672 to electrically connect the anchor 604 and the anchor fixture 602. In this embodiment, when in the locked position, both the anchor electrical element 680 and the fixture electrical element 672 are positioned on the same side of the vertical plane 645 defined by the anchor lock 632, such that electrical contact occurs on the same side. In other words, when rotated into the locked position, the anchor electrical element 680 becomes forward facing (contacting the rearward facing fixture electrical element 672), resulting in electrical contact between the anchor electrical element 680 and the fixture electrical element 672 in a front portion of the system 600. It is contemplated that, in other embodiments, the location of the electrical contact may vary. For example, the fixture electrical element 672 may be positioned on the connector portion 603 to be forward facing, while the anchor electrical element 680 may be positioned such that, when in the locked position, it is rearward facing relative to the fixture electrical element 672, resulting in electrical contact in a rear portion of the system 600. In this embodiment, as the cams 633 and the connector portion 603 are disposed below the bottom surface 611 of the fixture body 606, the electrical contact between the anchor electrical element 680 and the fixture electrical element 672 is below the bottom surface 611 of the fixture body 606.

The anchor electrical element 680 includes a pair of anchor electrical contacts 682. The anchor electrical contacts 682 are arranged in a configuration corresponding to that of the fixture electrical contacts 674, such that, when in the anchor lock 632 is in the locked position, a first anchor electrical contact 682 is configured to contact a first fixture electrical contact 674, and a second anchor electrical contact 682 is configured to contact a second fixture electrical contact 674. As such, in this embodiment, the anchor electrical contacts 682 are disposed similarly to the fixture electrical contacts 674. That is, the anchor electrical contacts 682 are in a side-by-side configuration, horizontally aligned and laterally spaced apart from one another. It is contemplated that, in other embodiments, the number and arrangement of anchor electrical contacts 682 may vary.

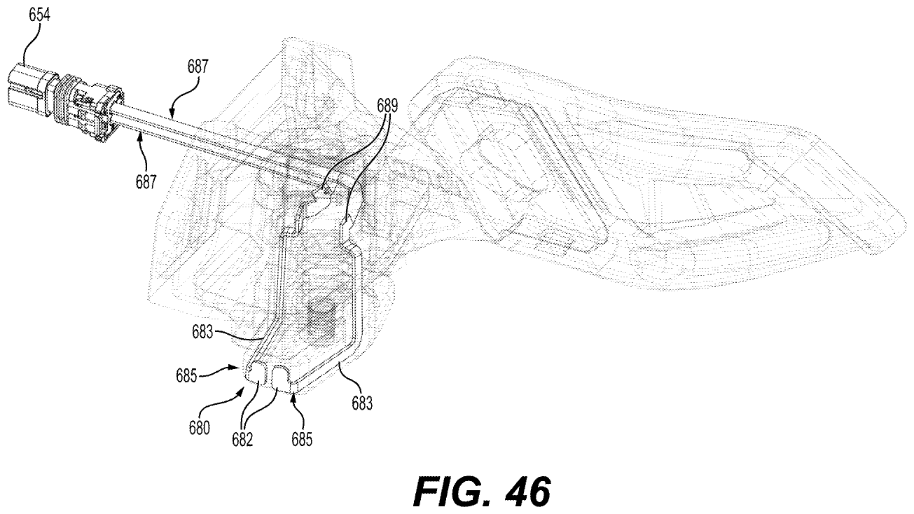

With reference to FIG. 46, the anchor electrical contacts 682 are connected to electrical leads 683, with each anchor electrical contact 682 being electrically connected to one end 685 of a respective electrical lead 683. The electrical leads 683 extend from the anchor electrical contacts 682, along the cam 633 towards the stem 642, and up along the stem 642. The portion of the electrical leads 683 extending along the cam 633 and the stem 642 can rotate with rotation of the anchor lock 632 via rotation of the lever 646. The electrical leads 683 exit at the intersection between the stem 642 and the lever 646. In the present embodiment, the lever 646 defines a slot 647 (depicted in FIG. 45) through which the electrical leads 683 extend from. The electrical leads 683 extend through an electrical lead opening 637 defined in the anchor base 630, specifically in the upright portion 638 of the anchor base 630, and each end 687 of the electrical lead 683 is electrically connected to an anchor power connector 654, which is described below. In the present embodiment, the electrical leads 683 are flexible wires 683 which can bend and flex as the stem 642 and cams 633 rotate. It is contemplated that the electrical leads 683 may be any suitable conductors for establishing electrical communication between the anchor electrical contacts 682 and the anchor power connector 654 through the anchor 604.

As mentioned above, the anchor 604 includes the anchor power connector 654 configured to electrically connect the anchor 604 to the accessory 75. In this embodiment, the anchor power connector 654 is a power receptacle configured for receiving a power plug that is electrically connected to the accessory 75 via wiring (not depicted). However, this may vary in other embodiments.

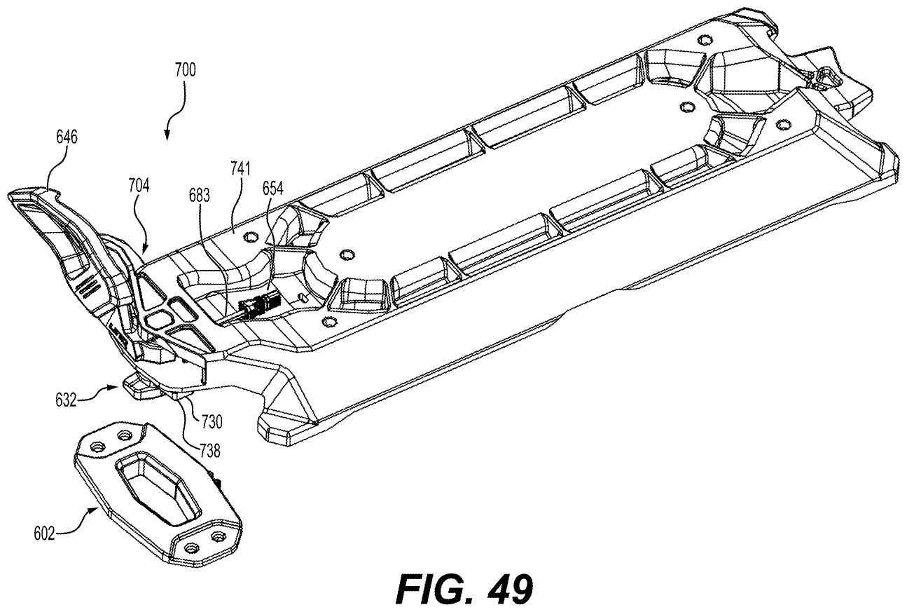

With reference to FIG. 49, an alternative embodiment of a system 700 is depicted. It is noted that the system 700 is generally similar to the system 600, except for the configuration of the anchor 704. Accordingly, for clarity, only the anchor 704 will be described in further detail. Features of the system 700 that are similar to those of the system 600 are identified with the same reference numerals and will not be described again.

In this embodiment, the anchor 704 includes an anchor base 730. The anchor base 730 includes a horizontal portion 736, defining a horizontal base plane. A plate 741 is connected to the anchor base 730 and configured to support the accessory 75. Specifically, a portion of a bottom side of the plate 741 abuts a top face of the anchor base 730. In this embodiment, the plate 741 defines and extends along a horizontal plate plane which is substantially parallel to the horizontal base plane defined by the anchor base 730. The plate 741 further defines an electrical lead opening (not depicted) through which the electrical leads 683 from the anchor electrical element 680 are fed, connecting to the anchor power connector 654. It is contemplated that, in some embodiments, the plate 741 may be integrally formed with the anchor base 730. In further alternative embodiments, the anchor base 730 may be omitted and the anchor lock 632 may extend from the plate 741.

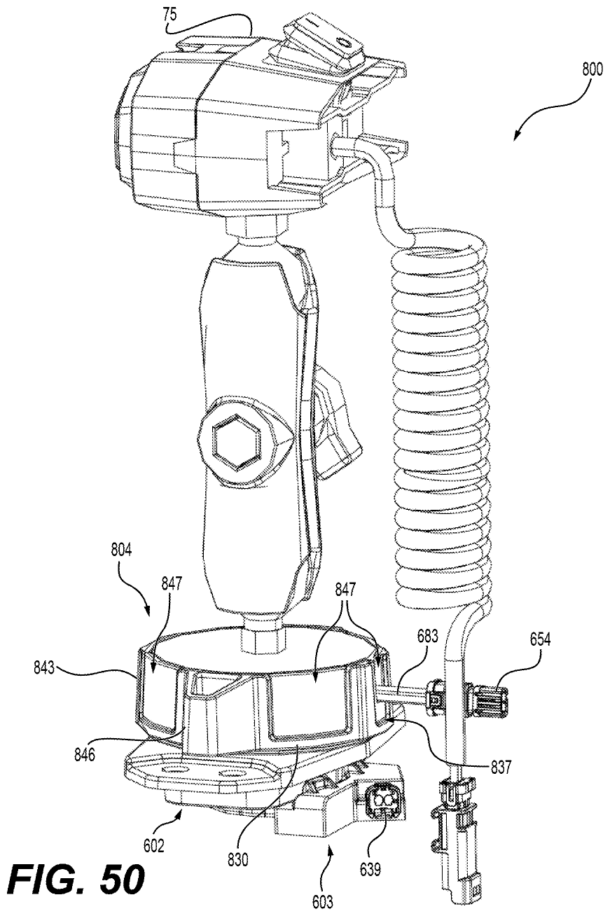

With reference to FIG. 50, an alternative embodiment of a system 800 is depicted. It is noted that the system 800 is generally similar to the system 600, except for the configuration of the anchor 804. Accordingly, for clarity, only the anchor 804 will be described in further detail. Features of the system 800 that are similar to those of the system 600 are identified with the same reference numerals and will not be described again.

In this embodiment, the anchor 804 includes an anchor base 830 which is configured to receive a bottom 77 of the accessory 75, which is a light 75. When the anchor lock (not depicted) is in the locked position, and the light 75 is connected to the anchor power connector 654, the light 75 is activatable.

The anchor base 830 includes an upright sidewall 843 that defines a substantially cylindrical shape. In this embodiment, the upright sidewall 843 defines a plurality of recesses 847 configured as slots, one of which serves as an electrical lead opening 837 for receiving the electrical leads 683 that connect to the anchor power connector 654. The anchor 804 further includes two levers 846 (only one of which is depicted) connected to the upright sidewall 843, with each lever 846 disposed on opposite sides of the anchor base 830. In the present embodiment, the levers 846 are integrally formed with the upright sidewall 843. However, in other embodiments, the levers 846 may be separate components and secured to the upright sidewall 843 using suitable methods (i.e., welding or gluing).

It is contemplated that, in other embodiments, the roles of the anchor 604, 704, 804 and the anchor fixture 602 may be reversed. Notably, in some embodiments, the anchor fixture 602 could be connected to the accessory 75 (rather than the snowmobile 10), and the anchor 604, 704, 804 could be connected to the snowmobile 10 (rather than the accessory 75). For instance, in such embodiments, the anchor fixture 602 and the anchor 604, 704, 804 may be electrically connected to the accessory 75 and the power source respectively.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A system for connecting an accessory to an item, the system comprising:
an anchor fixture comprising:
a fixture body configured to be connected to the item, the fixture body defining an anchor aperture; and
a connector portion connected to the fixture body, the connector portion having a first electrical element configured to electrically connect to an electrical power source; and
an anchor comprising:
an anchor base configured to be connected to the accessory; and
an anchor lock connected to the anchor base, the anchor lock being configured to be inserted through the anchor aperture of the anchor fixture, the anchor lock including a second electrical element configured to electrically connect to the accessory,
the anchor lock being movable relative to the anchor fixture between an unlocked position and a locked position,
in the locked position, the anchor lock is prevented from passing through the anchor aperture and the second electrical element contacts the first electrical element to electrically connect the anchor fixture to the anchor,
in the unlocked position, the anchor lock is free to pass through the anchor aperture and the second electrical element does not contact the first electrical element; and
the anchor being selectively secured to the anchor fixture by inserting the anchor lock through the anchor aperture and moving the anchor lock relative to the anchor fixture to place the anchor lock in the locked position.

2. The system of claim 1, wherein the connector portion is removably connected to the fixture body.

3. The system of claim 1, wherein:
the anchor base includes a first face;
the fixture body includes:
a first surface, at least a portion of the first surface being in contact with the first face of the anchor base when the anchor lock is selectively inserted through the anchor aperture; and
a second surface; and
the connector portion being connected to the second surface of the fixture body.

4. The system of claim 3, wherein the second surface of the fixture body is opposite to the first surface of the fixture body.

5. The system of claim 3, wherein the first electrical element is positioned on the connector portion such that the second surface of the fixture body is located between the first surface and the first electrical element.

6. The system of claim 1, wherein:
the anchor lock defines a plane, the plane contains and extends along a central axis of the anchor lock;
the first electrical element being disposed on a first side of the plane; and
in the locked position, the second electrical element contacts the first electrical element on the first side of the plane.

7. The system of claim 6, wherein:
the first electrical element is a first pair of electrical contacts; and
the second electrical element is a second pair of electrical contacts.

8. The system of claim 1, wherein the second electrical element is connected to a first end of an electrical lead, the electrical lead extending from the anchor lock towards the anchor base, at least a portion of the electrical lead being movable with the anchor lock.

9. The system of claim 8, wherein:
the anchor base defines an electrical lead opening; and
a second end of the electrical lead extending through the electrical lead opening.

10. The system of claim 9, wherein the anchor further comprises an anchor power connector electrically connected to the second end of the electrical lead, the anchor power connector being connectable to the accessory for electrically connecting the anchor to the accessory.

11. The system of claim 1, wherein:
the anchor further comprises a stem extending from the anchor base, the anchor lock extending away from the stem;
the anchor lock comprises at least one cam extending from the stem; and
the first electrical element being disposed on the at least one cam.

12. The system of claim 1, wherein the connector portion further comprises a fixture power connector electrically connected to the first electrical element, the fixture power connector being connectable to the item for electrically connecting the anchor fixture to the item.

13. The system of claim 1, wherein the anchor lock is rotatable relative to the anchor base.

14. The system of claim 1, wherein the anchor further comprises a lever operatively connected to the anchor lock, the lever being rotatable to cause the anchor lock to rotate between the locked position and the unlocked position.

15. The system of claim 1, wherein the fixture body defines a recessed portion extending inwardly from an outer edge of the fixture body.

16. The system of claim 1, wherein the anchor further comprises a plate connected to the anchor base.

17. The system of claim 1, further comprising the accessory, wherein:
the accessory is a light connected to the anchor base, the light being activatable when the anchor lock is in the locked position.

18. The system of claim 1, wherein the item is a part of a vehicle.
